(19) United States
(12) Patent Application Publication
(10) Pub. No.: US 2026/0244681 A1
(43) Pub. Date: Aug. 20, 2026

(54) WEARABLE DEVICE AND METHOD FOR EXECUTING SEARCHING BASED ON GESTURE

(71) Applicant: SAMSUNG ELECTRONICS CO., LTD., Suwon-si (KR)

(72) Inventors: Daechan JANG, Suwon-si (KR); Sungoh KIM, Suwon-si (KR); Sanghun LEE, Suwon-si (KR)

(73) Assignee: SAMSUNG ELECTRONICS CO., LTD., Suwon-si (KR)

(21) Appl. No.: 19/446,195

(22) Filed: Jan. 12, 2026

Related U.S. Application Data
(63) Continuation of application No. PCT/KR2025/022389, filed on Dec. 19, 2025.

(30) Foreign Application Priority Data
Feb. 14, 2025 (KR) 10-2025-0019749
Apr. 17, 2025 (KR) 10-2025-0050507
Jul. 22, 2025 (KR) 10-2025-0099182

(51) Int. Cl. G06F 16/532; G06F 1/16; G06F 3/01; G06V 40/20

(52) U.S. Cl. CPC G06F 16/532; G06F 1/163; G06F 3/017; G06V 40/20

(57) ABSTRACT

A wearable device includes a camera, a display, a processor, and memory storing instructions. The instructions, when executed by the at least one processor, cause the wearable device to execute a mode for searching based on a user input, perform gesture recognition based on the mode being executed, display a trajectory of the gesture based on the mode being executed, identify an image frame in which a location of an input object corresponds to a lower part of the trajectory among image frames captured while the mode is executed, identify an image region of the identified image frame in accordance with the gesture based on completion of the gesture, and execute searching for the image region of the identified image frame.

### CROSS-REFERENCE TO RELATED APPLICATIONS

This application is a continuation application of International Application No. PCT/KR2025/022389, filed on December 19, 2025, which is based on and claims priority to Korean Patent Application No. 10-2025-0019749, filed on February 14, 2025, Korean Patent Application No. 10-2025-0050507, filed on April 17, 2025, and Korean Patent Application No. 10-2025-0099182, filed on July 22, 2025, in the Korean Intellectual Property Office, the disclosures of which iares incorporated by reference herein in their entireties.

### BACKGROUND

### Field

The disclosure relates to a wearable device and a method for executing searching based on a gesture.

### Description of Related Art

A user of a wearable device may experience a virtual world via virtual reality (VR), augmented reality (AR), and/or mixed reality (MR) in a state of wearing the wearable device on a head. For example, the wearable device may provide a mode for searching based on a gesture. For example, in a state of wearing the wearable device, the user may move an input object (e.g., the user’s hand or a controller for the wearable device) for the gesture while the mode is executing.

The above-described information may be provided as a related art for the purpose of helping understanding of the present disclosure. No argument or decision is made as to whether any of the above description may be applied as a prior art related to the present disclosure.

### SUMMARY

A wearable device is provided. The wearable device may include a first camera, a second camera, a display, at least one processor comprising processing circuitry, and memory comprising one or more storage media storing instructions. The first camera may be configured to capture images corresponding to a field of view of a user wearing the wearable device. The second camera may be configured to capture images for gesture recognition. The instructions, when executed by the at least one processor individually or collectively, may cause the wearable device to operate the first camera to capture the images corresponding to the field of view. The instructions, when executed by the at least one processor individually or collectively, may cause the wearable device to, based on at least a portion of the captured images corresponding to the field of view, display, via the display, pass-through images corresponding to the field of view. The instructions, when executed by the at least one processor individually or collectively, may cause the wearable device to execute a mode for searching based on a user input. The instructions, when executed by the at least one processor individually or collectively, may cause the wearable device to, based on the mode being executed, perform, using images obtained via the second camera, gesture recognition to identify a gesture. The instructions, when executed by the at least one processor individually or collectively, may cause the wearable device to, while the mode is executed, display, via the display, a trajectory of the gesture. The trajectory may comprise a first portion of the gesture and a second portion of the gesture. A location of an input object in the first portion of the trajectory may be below a location of the input object in the second portion of the trajectory. The instructions, when executed by the at least one processor individually or collectively, may cause the wearable device to identify an image frame of a pass-through image among the pass-through images in which the location of the input object corresponds to the first portion of the trajectory from among image frames captured while the mode for searching is executed. The instructions, when executed by the at least one processor individually or collectively, may cause the wearable device to, based on a completion of the gesture, identify an image region of the identified image frame in accordance with the gesture. The instructions, when executed by the at least one processor individually or collectively, may cause the wearable device to transmit a request to execute searching for the image region of the identified image frame.

A non-transitory computer readable storage medium is provided. The non-transitory computer readable storage medium may store one or more programs. The one or more programs may comprise instructions to, when executed by a wearable device with a first camera configured to capture images corresponding to a field of view of a user wearing the wearable device, a second camera configured to capture images for gesture recognition, and a display, cause the wearable device to operate the first camera to capture the images corresponding to the field of view. The one or more programs may comprise instructions to, when executed by the wearable device, cause the wearable device to, based on at least a portion of the captured images corresponding to the field of view, display, via the display, pass-through images corresponding to the field of view. The one or more programs may comprise instructions to, when executed by the wearable device, cause the wearable device to execute a mode for searching based on a user input. The one or more programs may comprise instructions to, when executed by the wearable device, cause the wearable device to, while the mode is executed, perform, using images obtained via the second camera, gesture recognition to identify a gesture. The one or more programs may comprise instructions to, when executed by the wearable device, cause the wearable device to, based on the mode being executed, display, via the display, a trajectory of the gesture. The trajectory may comprise a first portion of the gesture and a second portion of the gesture. A location of an input object in the first portion of the trajectory may be below a location of the input object in the second portion of the trajectory. The one or more programs may comprise instructions to, when executed by the wearable device, cause the wearable device to identify an image frame of a pass-through image among the pass-through images in which the location of the input object corresponds to the first portion of the trajectory from among image frames captured while the mode for searching is executed. The one or more programs may comprise instructions to, when executed by the wearable device, cause the wearable device to, based on a completion of the gesture, identify an image region of the identified image frame in accordance with the gesture. The one or more programs may comprise instructions to, when executed by the wearable device, cause the wearable device to transmit a request to execute searching for the image region of the identified image frame.

A method is provided. The method may be performed by a wearable device with a first camera configured to capture images corresponding to a field of view of a user wearing the wearable device, a second camera configured to capture images for gesture recognition, and a display. The method may comprise operating the first camera to capture the images corresponding to the field of view. The method may comprise, based on at least a portion of the captured images corresponding to the field of view, displaying, via the display, pass-through images corresponding to the field of view. The method may comprise executing a mode for searching based on a user input. The method may comprise, based on the mode being executed, performing, using images obtained via the second camera, gesture recognition to identify a gesture. The method may comprise, based on the mode being executed, displaying, via the display, a trajectory of the gesture. The trajectory may comprise a first portion of the gesture and a second portion of the gesture. A location of an input object in the first portion of the trajectory may be lower than a location of the input object in the second portion of the trajectory. The method may comprise identifying an image frame of a pass-through image among the pass-through images in which the location of the input object corresponds to the first portion of the trajectory from among image frames captured while the mode for searching is executed. The method may comprise, based on a completion of the gesture, identifying an image region of the identified image frame in accordance with the gesture. The method may comprise transmitting a request to execute searching for the image region of the identified image frame.

A wearable device is provided. The wearable device may include a first camera, a second camera, a display, at least one processor comprising processing circuitry, and memory comprising one or more storage media storing instructions. The first camera may be configured to capture images corresponding to a field of view of a user wearing the wearable device. The second camera may be configured to capture images for gesture recognition. The instructions, when executed by the at least one processor individually or collectively, may cause the wearable device to operate the first camera to capture images corresponding to the field of view. The instructions, when executed by the at least one processor individually or collectively, may cause the wearable device to, based on at least a portion of the captured images corresponding to the field of view, display, via the display, pass-through images corresponding to the field of view. The instructions, when executed by the at least one processor individually or collectively, may cause the wearable device to execute a mode for searching based on a user input. The instructions, when executed by the at least one processor individually or collectively, may cause the wearable device to store an image frame captured in response to the execution of the mode. The instructions, when executed by the at least one processor individually or collectively, may cause the wearable device to, based on the mode being executed, perform, using images obtained via the second camera, gesture recognition to identify a gesture. The instructions, when executed by the at least one processor individually or collectively, may cause the wearable device to, while the mode is executed, display, via the display, a trajectory of the gesture. The instructions, when executed by the at least one processor individually or collectively, may cause the wearable device to, based on a completion of the gesture, identify an image region of the image frame in accordance with the gesture. The instructions, when executed by the at least one processor individually or collectively, may cause the wearable device to transmit a request to execute searching for the image region of the image frame.

A non-transitory computer readable storage medium is provided. The non-transitory computer readable storage medium may store one or more programs. The one or more programs may comprise instructions to, when executed by a wearable device with a first camera configured to capture images corresponding to a field of view of a user wearing the wearable device, a second camera configured to capture images for gesture recognition, and a display, cause the wearable device to operate the first camera to capture images corresponding to the field of view. The one or more programs may comprise instructions to, when executed by the wearable device, cause the wearable device to, based on at least a portion of the captured images corresponding to the field of view, display, via the display, pass-through images corresponding to the field of view. The one or more programs may comprise instructions to, when executed by the wearable device, cause the wearable device to execute a mode for searching based on a user input. The one or more programs may comprise instructions to, when executed by the wearable device, cause the wearable device to store an image frame captured in response to the execution of the mode. The one or more programs may comprise instructions to, when executed by the wearable device, cause the wearable device to, based on the mode being executed, perform, using images obtained via the second camera, gesture recognition to identify a gesture. The one or more programs may comprise instructions to, when executed by the wearable device, cause the wearable device to, based on the mode being executed, display, via the display, a trajectory of the gesture. The one or more programs may comprise instructions to, when executed by the wearable device, cause the wearable device to, based on a completion of the gesture, identify an image region of the image frame in accordance with the gesture. The one or more programs may comprise instructions to, when executed by the wearable device, cause the wearable device to transmit a request to execute searching for the image region of the image frame.

A method is provided. The method may be performed by a wearable device with a first camera configured to capture images corresponding to a field of view of a user wearing the wearable device, a second camera configured to capture images for gesture recognition, and a display. The method may comprise operating the first camera to capture images corresponding to the field of view. The method may comprise, based on at least a portion of the captured images corresponding to the field of view, displaying, via the display, pass-through images corresponding to the field of view. The method may comprise executing a mode for searching based on a user input. The method may comprise storing an image frame captured in response to the execution of the mode. The method may comprise, based on the mode being executed, performing, using images obtained via the second camera, gesture recognition to identify a gesture. The method may comprise, based on the mode being executed, displaying, via the display, a trajectory of the gesture. The method may comprise, in response to completion of the gesture, identifying an image region of the image frame in accordance with the gesture. The method may comprise transmitting a request to execute searching for the image region of the image frame.

A wearable device is provided. The wearable device may include a camera, at least one processor comprising processing circuitry, and memory comprising one or more storage media storing instructions. The instructions, when executed by the at least one processor individually or collectively, may cause the wearable device to determine a selection region based at least in part on a user gesture performed within a range included at least once in a field of view (FoV) of the camera in a gesturing process from a time point when a selection region capture function is activated, such that a first shooting is performed within a selection region capture period, which is until a time point when a final capture image is determined, based on an image included in the selection region. The instructions, when executed by the at least one processor individually or collectively, may cause the wearable device to determine whether an object associated with the user gesture is included in a first selection region, which is a region substantially equal to the selection region, included in a first image obtained based on a result of the first shooting. The instructions, when executed by the at least one processor individually or collectively, may cause the wearable device to determine an image excluding a portion or all of an object associated with the user gesture in the selection region as the final capture image.

A method is provided. The method may be performed by a wearable device with a camera. The method may comprise determining a selection region based at least in part on a user gesture performed within a range included at least once in a field of view (FoV) of the camera in a gesturing process from a time point when a selection region capture function is activated and performing a first shooting within a selection region capture period, which is until a time point when a final capture image is determined, based on an image of the selection region. The method may determine whether an object associated with the user gesture is included in the selection region included in a first image obtained based on a result of the first shooting. The method may comprise determining an image excluding a portion or all of an object associated with the user gesture in the selection region as the final capture image.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view of an example wearable device according to an embodiment;

FIGS. 2A and 2B illustrate an example of a wearable device according to an embodiment;

FIG. 2C illustrates an example of a wearable device according to an embodiment;

FIGS. 3A and 3B illustrate an example of a wearable device according to an embodiment;

FIG. 4 illustrates an example of a usage environment of a wearable device to execute searching based on a gesture;

FIG. 5 illustrates an example of a system to execute searching based on a gesture via a wearable device;

FIG. 6 is a flowchart illustrating a method of identifying an image frame for searching among image frames captured via a camera based on a location of a trajectory for a gesture, according to an embodiment;

FIG. 7 is a flowchart illustrating a method of correcting an image frame for searching identified based on a location of a trajectory for a gesture in accordance with an orientation of a wearable device, according to an embodiment;

FIG. 8 is an example of a usage environment of a wearable device to execute searching for an image frame corresponding to the lowest location of an input object for a gesture, according to an embodiment;

FIG. 9 is a flowchart illustrating a method of identifying an image frame captured via a camera as an image frame for searching in response to execution of a mode for searching based on a gesture, according to an embodiment;

FIG. 10 is a flowchart illustrating a method of correcting an image frame for searching identified in response to execution of a mode for searching based on a gesture in accordance with an orientation of a wearable device, according to an embodiment;

FIG. 11 is an example of a usage environment of a wearable device to execute searching for an image frame stored in response to execution of a mode for searching based on a gesture, according to an embodiment;

FIG. 12 is a flowchart illustrating a method of determining one of an image frame corresponding to the lowest location of an input object for a gesture and an image frame identified in response to execution of a mode for searching based on a gesture as an image frame for searching based on a gesture, according to an embodiment;

FIG. 13 is a flowchart illustrating a method of identifying an image frame for searching among image frames captured via a camera in accordance with the number of joints of an input object for a gesture, according to an embodiment;

FIG. 14 is a flowchart illustrating a method of determining an image excluding an input object for a gesture among images captured via a camera as an image for searching, according to an embodiment; and

FIG. 15 is a block diagram of an electronic device in a network environment according to various embodiments.

### DETAILED DESCRIPTION

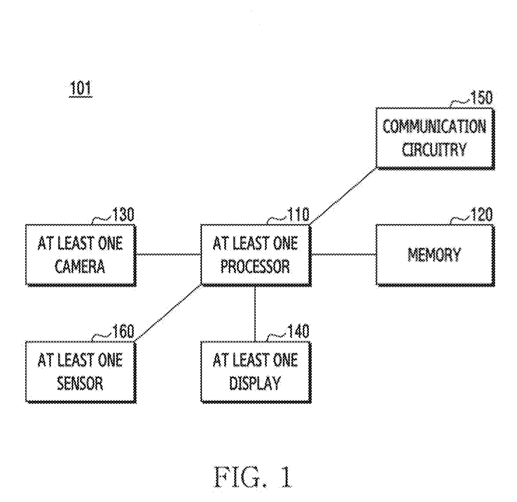

FIG. 1 is a schematic view of an example wearable device according to an embodiment.

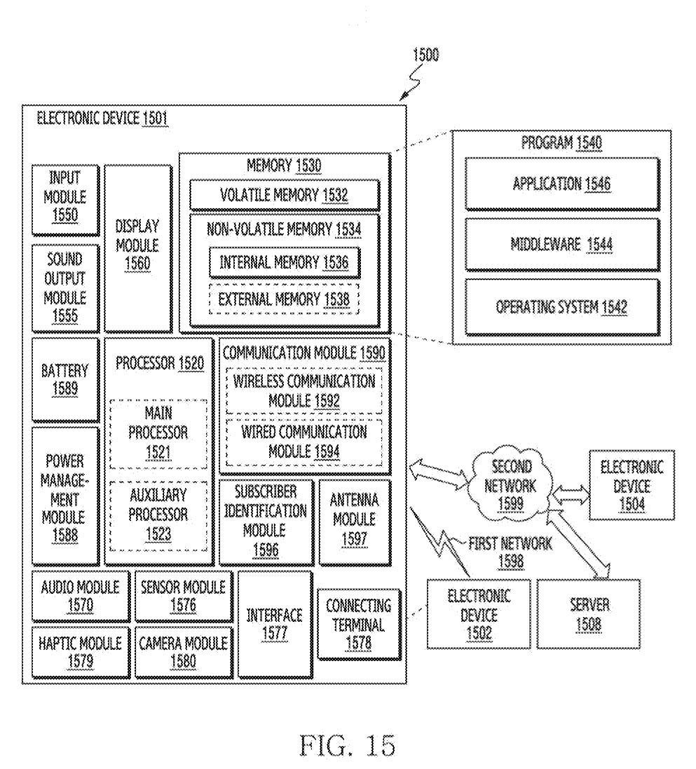

Referring to FIG. 1, a wearable device 101 may include at least one processor 110, memory 120, at least one camera 130, at least one display 140, communication circuitry 150, and at least one sensor 160. The wearable device 101 may include at least a portion of an electronic device 1501 of FIG. 15 or may correspond to at least a portion of the electronic device 1501 of FIG. 15. For example, the wearable device 101 may be described as an electronic device wearable on a user’s head.

The at least one processor 110 may include processing circuitry. The at least one processor 110 may include a single processor or multiple processors. The at least one processor 110 may control the memory 120 and/or one or more components (e.g., the at least one camera 130, the at least one display 140, the communication circuitry 150, and/or the at least one sensor 160) of the wearable device 101. For example, the at least one processor 110 may include at least a portion of a processor 1520 of FIG. 15 or may correspond to at least a portion of the processor 1520 of FIG. 15.

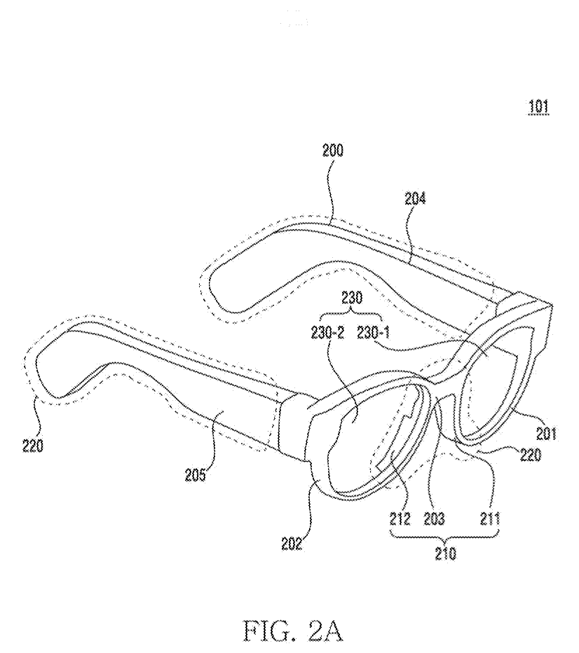

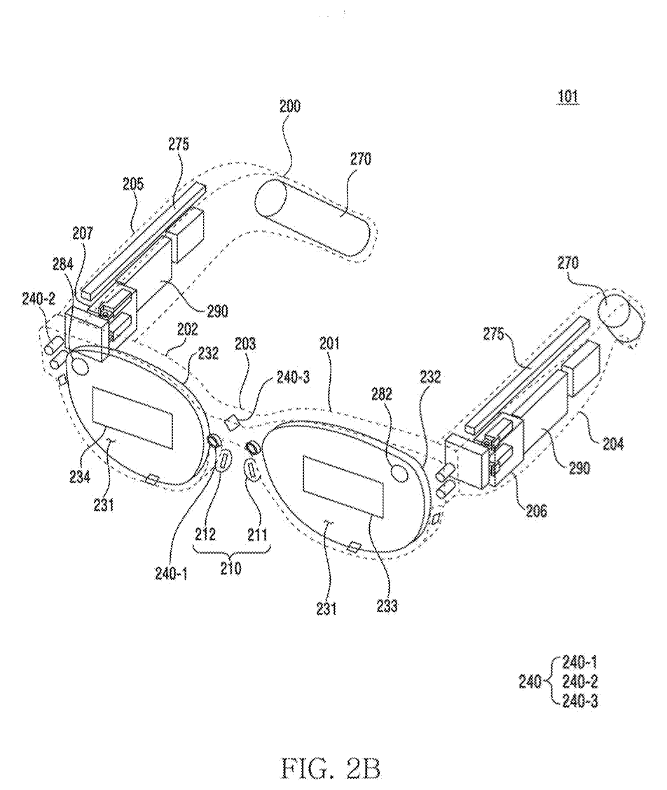

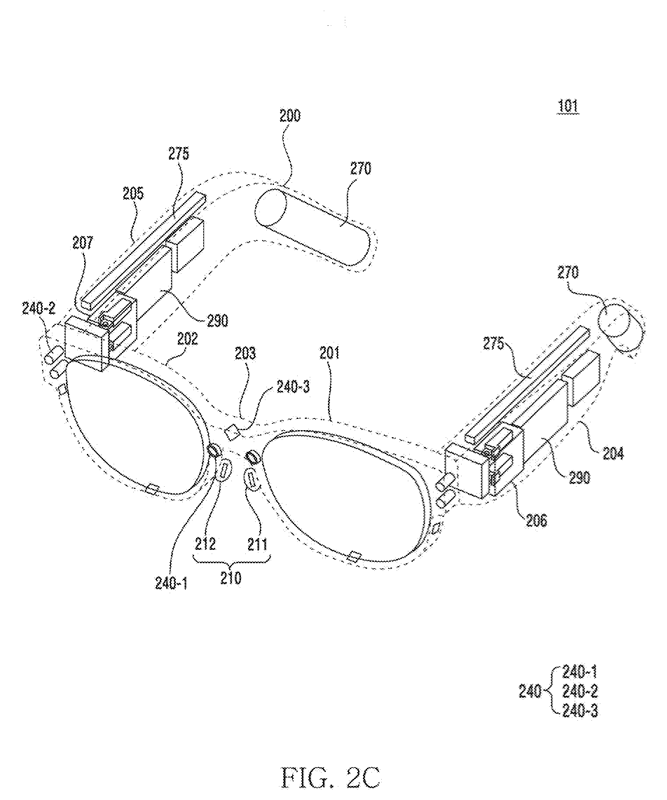

The memory 120 may store one or more programs configured to be individually and/or collectively executed by the at least one processor 110. The one or more programs may include instructions. The instructions may cause the wearable device 101 to perform operations described with reference to FIGS. 2A to 14. The memory 120 may include one or more storage media. At least a portion of the one or more programs may be available to manage, control, and/or execute a mode for searching based on a gesture, as described below. For example, the memory 120 may include at least a portion of memory 1530 of FIG. 15 or may correspond to at least a portion of the memory 1530 of FIG. 15.

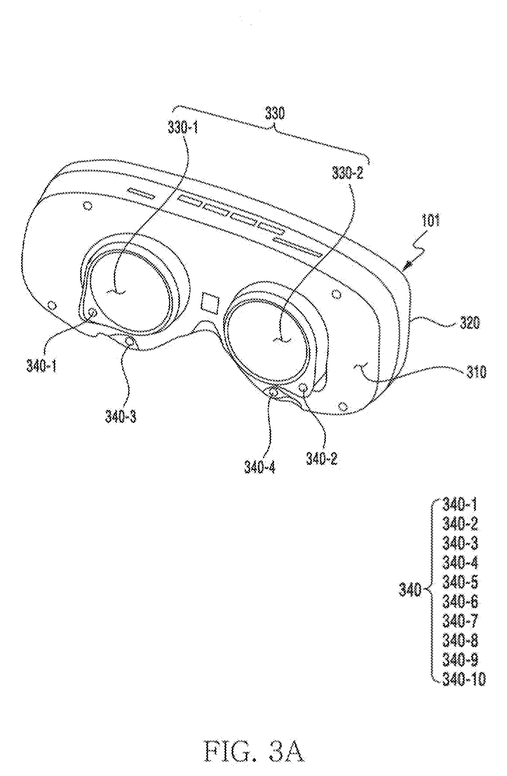

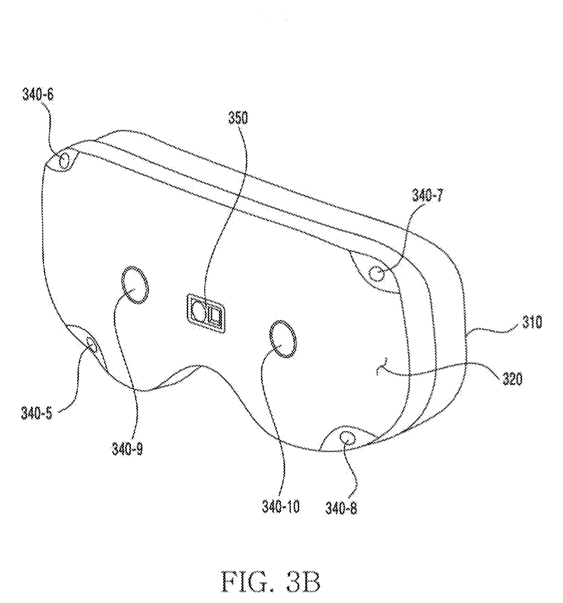

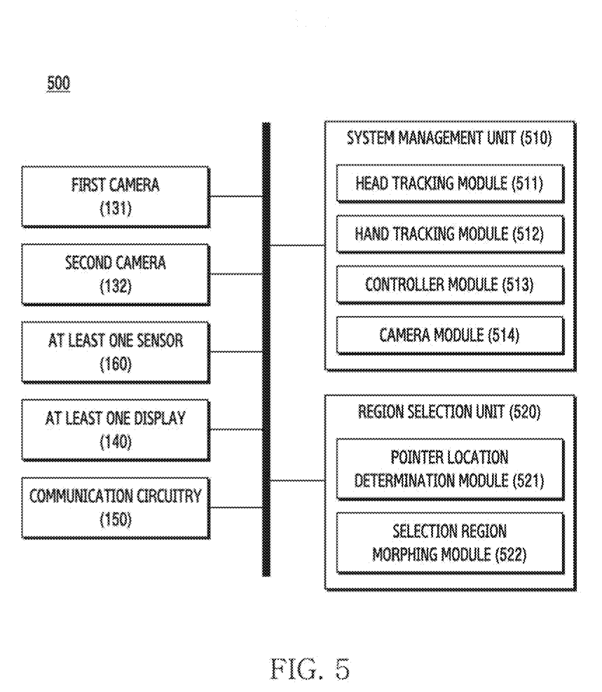

The at least one camera 130 may capture (or shoot) an image (e.g., a still image) and a video. For example, images obtained sequentially (or continuously) via the at least one camera 130 may be referred to as an image frame. For example, the at least one camera 130 may include one or more lenses, image sensors, and/or flashes. For example, the at least one camera 130 may include at least a portion of a camera 240 of FIG. 2B or may correspond to at least a portion of the camera 240 of FIG. 2B. For example, the at least one camera 130 may include at least a portion of a camera 340 of FIGS. 3A and 3B or may correspond to at least a portion of the camera 340 of FIGS. 3A and 3B. For example, the at least one camera 130 may include a first camera 131 and a second camera 132 of FIG. 5. For example, the at least one camera 130 may include at least a portion of a camera module 1580 of FIG. 15 or may correspond to at least a portion of the camera module 1580 of FIG. 15.

The at least one display 140 may visually provide information to the outside (e.g., a user) of the wearable device 101. For example, the at least one display 140 may include a first display and a second display spaced apart from each other. For example, the first display may be disposed in a housing of the wearable device 101 at a location corresponding to a user’s left eye, and the second display may be disposed in the housing of the wearable device 101 at a location corresponding to a user’s right eye. For example, the at least one display 140 may include a display panel and/or a touch sensor. For example, the display panel may be used to display visual information (e.g., an image, a screen, an object, a user interface (UI), a graphic user interface (GUI), and/or a visual object). For example, the display panel may have a display region capable of receiving a touch input. For example, the touch sensor may be used to obtain data on an external object located on the display panel. For example, the touch sensor may be located in or on the display panel to provide a region of the display panel capable of receiving the touch input. For example, the touch sensor may be configured to obtain data on contact points on at least a portion of the region. For example, the at least one display 140 may include at least a portion of at least one display 230 of FIG. 2A or may correspond to at least a portion of the at least one display 230 of FIG. 2A. For example, the at least one display 140 may include at least a portion of at least one display 330 of FIG. 3A or may correspond to at least a portion of the at least one display 330 of FIG. 3A. For example, the at least one display 140 may include at least a portion of a display module 1560 of FIG. 15 or may correspond to at least a portion of the display module 1560 of FIG. 15.

The communication circuitry 150 may support establishment of a wireless communication (e.g., Bluetooth) channel between the wearable device 101 and an external electronic device (e.g., a controller for the wearable device 101) and performance of communication via the established communication channel. For example, the communication circuitry 150 may include at least a portion of a communication module 1590 of FIG. 15 or may correspond to at least a portion of the communication module 1590 of FIG. 15.

The at least one sensor 160 may include one or more sensors for detecting (or identifying) an orientation of the wearable device 101. For example, the orientation of the wearable device 101 may be described as a location and a rotation angle of the wearable device 101 with respect to each of reference axes (e.g., an x-axis, a y-axis, and a z-axis). For example, the one or more sensors may include an acceleration sensor for detecting linear acceleration of the wearable device 101, a gyroscope sensor for detecting a rotational angular velocity of the wearable device 101, and/or a gravity sensor for detecting gravity applied to the wearable device 101. For example, the one or more sensors may detect the orientation of the wearable device 101 based on sensing data obtained via the acceleration sensor, the gyroscope sensor, and/or the gravity sensor. For example, the one or more sensors may be referred to as an inertia measurement unit (IMU) sensor. For example, the at least one sensor 160 may include at least a portion of a sensor module 1576 of FIG. 15 or may correspond to at least a portion of the sensor module 1576 of FIG. 15.

FIGS. 2A and 2B illustrate an example of a wearable device according to an embodiment.

Referring to FIG. 2A, an example of a perspective view of a wearable device 101 is illustrated. Referring to FIG. 2B, an example of one or more hardware disposed in the wearable device 101 is illustrated. The wearable device 101 illustrated in FIGS. 2A and 2B may be referred to as a head-wearable electronic device that may be worn on a user’s head. For example, the wearable device 101 illustrated in FIGS. 2A and 2B may be referred to as augmented reality (AR) glasses that provide an augmented reality image in which a virtual reality image displayed via a display is combined with a reality screen transmitted via the display.

According to an embodiment, the wearable device 101 may be wearable on a portion of the user’s body. The wearable device 101 may provide augmented reality (AR), virtual reality (VR), or mixed reality (MR) combining the augmented reality and the virtual reality to a user wearing the wearable device 101. For example, the wearable device 101 may display a virtual reality image provided from at least one optical device 282 and 284 (e.g., the first optical device 282 and the second optical device 284) of FIG. 2B on at least one display 230 , in response to a user’s preset gesture obtained through a motion recognition camera 240-2 of FIG. 2B.

According to an embodiment, the at least one display 230 may provide visual information to a user. For example, the at least one display 230 may include a transparent or translucent lens. The at least one display 230 may include a first display 230-1 and/or a second display 230-2 spaced apart from the first display 230-1. For example, the first display 230-1 and the second display 230-2 may be disposed at positions corresponding to the user’s left and right eyes, respectively.

Referring to FIG. 2B, the at least one display 230 may provide visual information transmitted through a lens included in the at least one display 230 from ambient light to a user and other visual information distinguished from the visual information2. The lens may be formed based on at least one of a fresnel lens, a pancake lens, or a multi-channel lens. For example, the at least one display 230 may include a first surface 231 and a second surface 232 opposite to the first surface 231. A display area may be formed on the second surface 232 of at least one display 230. When the user wears the wearable device 101, ambient light may be transmitted to the user by being incident on the first surface 231 and being penetrated through the second surface 232. For another example, the at least one display 230 may display an augmented reality image in which a virtual reality image provided by the at least one optical device 282 and 284 is combined with a reality screen transmitted through ambient light, on a display area formed on the second surface 232.

According to an embodiment, the at least one display 230 may include at least one waveguide 233 and 234 (e.g., the first waveguide 233 and the second waveguide 234) that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 101 to guide a screen displayed by the at least one display 230 to the user’s eyes. For example, the screen may be transmitted to the user’s eyes based on total internal reflection (TIR) generated in the at least one waveguide 233 and 234.

According to an embodiment, a frame 200 may be configured with a physical structure in which the wearable device 101 may be worn on the user’s body. According to an embodiment, the frame 200 may be configured so that when the user wears the wearable device 101, the first display 230-1 and the second display 230-2 may be positioned corresponding to the user’s left and right eyes. The frame 200 may support the at least one display 230. For example, the frame 200 may support the first display 230-1 and the second display 230-2 to be positioned at positions corresponding to the user’s left and right eyes.

Referring to FIG. 2A, according to an embodiment, the frame 200 may include an area 220 at least partially in contact with the portion of the user’s body in case that the user wears the wearable device 101. For example, the area 220 of the frame 200 in contact with the portion of the user’s body may include an area in contact with a portion of the user’s nose, a portion of the user’s ear, and a portion of the side of the user’s face that the wearable device 101 contacts. According to an embodiment, the frame 200 may include a nose pad 210 that is contacted on the portion of the user’s body. When the wearable device 101 is worn by the user, the nose pad 210 may be contacted on the portion of the user’s nose. The frame 200 may include a first temple 204 and a second temple 205 , which are contacted on another portion of the user’s body that is distinct from the portion of the user’s body.

For example, the frame 200 may include a first rim 201 surrounding at least a portion of the first display 230-1, a second rim 202 surrounding at least a portion of the second display 230-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer’s ear, and the second temple 205 extending from the second rim 202 and fixed to a portion of the ear opposite to the ear. The first pad 211 and the second pad 212 may be in contact with the portion of the user’s nose, and the first temple 204 and the second temple 205 may be in contact with a portion of the user’s face and the portion of the user’s ear. The first temple 204 and the second temple 205 may be rotatably connected to the rim through the first hinge unit 206 and the second hinge unit 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment, the wearable device 101 may identify an external object (e.g., a user’s fingertip) touching the frame 200 and/or a gesture performed by the external object by using a touch sensor, a grip sensor, and/or a proximity sensor formed on at least a portion of the surface of the frame 200.

According to an embodiment, the wearable device 101 may include hardware that perform various functions. For example, the hardware may include a battery module 270, an antenna module 275, the at least one optical device 282 and 284, a light emitting module, and/or a printed circuit board (PCB) 290. Various hardware may be disposed in the frame 200.

According to an embodiment, the wearable device 101 may include microphones. The microphones may obtain a sound signal, by being disposed on at least a portion of the frame 200. The microphones may include a microphone 265-1 disposed on the nose pad 210, a microphone 265-2 disposed on the first rim 201, and a microphone 265-3 disposed on the second rim 202. In case that the number of the microphones included in the wearable device 101 is two or more, the wearable device 101 may identify a direction of the sound signal by using a plurality of microphones disposed on different portions of the frame 200.

According to an embodiment, the at least one optical device 282 and 284 may project a virtual object on the at least one display 230 in order to provide various image information to the user. For example, the at least one optical device 282 and 284 may be a projector. The at least one optical device 282 and 284 may be disposed adjacent to the at least one display 230 or may be included in the at least one display 230 as a portion of the at least one display 230. According to an embodiment, the wearable device 101 may include a first optical device 282 corresponding to the first display 230-1, and a second optical device 284 corresponding to the second display 230-2. For example, the at least one optical device 282 and 284 may include the first optical device 282 disposed at a periphery of the first display 230-1 and the second optical device 284 disposed at a periphery of the second display 230-2. The first optical device 282 may transmit light to the first waveguide 233 disposed on the first display 230-1, and the second optical device 284 may transmit light to the second waveguide 234 disposed on the second display 230-2.

In an embodiment, a camera 240 may include a photographing camera, an eye tracking camera (ET CAM) 240-1, a motion recognition camera 240-2 and/or the photographing camera 240-3. The eye tracking camera 240-1, the motion recognition camera 240-2, and the photographing camera 240-3 may be disposed at different positions on the frame and may perform different functions. The eye tracking camera 240-1 may output data indicating a gaze of the user wearing the wearable device 101. For example, the wearable device 101 may detect the gaze from an image including the user’s pupil, obtained through the eye tracking camera 240-1. An example in which the eye tracking camera 240-1 is disposed toward the user’s right eye is illustrated in FIG. 2B, but the embodiment is not limited thereto, and the eye tracking camera 240-1 may be disposed alone toward the user’s left eye or may be disposed toward two eyes.

In an embodiment, the eye tracking camera 240-1 may implement a more realistic augmented reality by matching the user’s gaze with the visual information provided on the at least one display 230, by tracking the gaze of the user wearing the wearable device 101. For example, when the user looks at the front, the wearable device 101 may naturally display environment information associated with the user’s front on the at least one display 230 at a position where the user is positioned. The eye tracking camera 240-1 may be configured to capture an image of the user’s pupil in order to determine the user’s gaze. For example, the eye tracking camera 240-1 may receive gaze detection light reflected from the user’s pupil and may track the user’s gaze based on the position and movement of the received gaze detection light. In an embodiment, the eye tracking camera 240-1 may be disposed at a position corresponding to the user’s left and right eyes. For example, the eye tracking camera 240-1 may be disposed in the first rim 201 and/or the second rim 202 to face the direction in which the user wearing the wearable device 101 is positioned.

The motion recognition camera 240-2 may provide a specific event to the screen provided on the at least one display 230 by recognizing the movement of the whole or portion of the user’s body, such as the user’s torso, hand, or face. The motion recognition camera 240-2 may obtain a signal corresponding to motion by recognizing the user’s gesture, and may provide a display corresponding to the signal to the at least one display 230. A processor may identify a signal corresponding to the operation and may perform a preset function based on the identification. In an embodiment, the motion recognition camera 240-2 may be disposed on the first rim 201 and/or the second rim 202.

In an embodiment, the photographing camera 240-3 may photograph an actual image or background to be matched with a virtual image to implement augmented reality (AR) or mixed reality (MR) content. The photographing camera 240-3 may photograph an image of a specific object existing at a position viewed by a user, and provide the image to the at least one display 230. The at least one display 230 may display one image in which information on an actual image or background including the image of the specific object obtained using the photographing camera 240-3 and a virtual image provided through the at least one optical device 282 and 284 overlap. In an embodiment, the photographing camera 240-3 may be disposed on the bridge 203 disposed between the first rim 201 and the second rim 202. The wearable device 101 may analyze an object included in the reality image collected through the photographing camera 240-3, and may display, on the at least one display 230, a virtual object corresponding to an object among the analyzed objects that is a target of augmented reality provision by combining the virtual object. The virtual object may include at least one of text and an image for various information related to an object included in the real image. The wearable device 101 may analyze an object based on a multi-camera such as a stereo camera. For the object analysis, the wearable device 101 may perform time-of-flight (ToF) and/or simultaneous localization and mapping (SLAM), supported by a multi-camera. A user wearing the wearable device 101 may view an image displayed on the at least one display 230.

The camera 240 included in the wearable device 101 is not limited to the above-described eye tracking camera 240-1, the motion recognition camera 240-2, and the photographing camera 240-3. For example, the wearable device 101 may identify an external object included in the FoV by using the camera 240 disposed toward the user’s FoV. The wearable device 101 identifying the external object may be performed based on a sensor for identifying a distance between the wearable device 101 and the external object, such as a depth sensor and/or a time of flight (ToF) sensor. The camera 240 disposed toward the FoV may support an autofocus function and/or an optical image stabilization (OIS) function. For example, in order to obtain an image including a face of the user wearing the wearable device 101, the wearable device 101 may include the camera 240 (e.g., a face tracking (FT) camera) disposed toward the face.

The wearable device 101 according to an embodiment may further include a light source (e.g., LED) that emits light toward a subject (e.g., user’s eyes, face, and/or an external object in the FoV) photographed by using the camera 240. The light source may include an LED having an infrared wavelength. The light source may be disposed on at least one of the frame 200, and the first hinge unit 206 and the second hinge unit 207.

According to an embodiment, the battery module 270 may supply power to electronic components of the wearable device 101. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

In an embodiment, the antenna module 275 may transmit the signal or power to the outside of the wearable device 101 or may receive the signal or power from the outside. The antenna module 275 may be electrically and/or operatively connected to the communication circuit. In an embodiment, the antenna module 275 may be disposed in the first temple 204 and/or the second temple 205. For example, the antenna module 275 may be disposed close to one surface of the first temple 204 and/or the second temple 205.

According to an embodiment, the wearable device 101 may include a speaker. The speaker may output a sound signal to the outside of the wearable device 101. A sound output module may be referred to as a speaker. In an embodiment, the speaker may be disposed in the first temple 204 and/or the second temple 205 in order to be disposed adjacent to the ear of the user wearing the wearable device 101. For example, the speaker may include a first speaker disposed adjacent to the user’s left ear by being disposed in the first temple 204, and a second speaker disposed adjacent to the user’s right ear by being disposed in the second temple 205.

According to an embodiment, the light emitting module may include at least one light emitting element. The light emitting module may emit light of a color corresponding to a specific state or may emit light through an operation corresponding to the specific state in order to visually provide information on a specific state of the wearable device 101 to the user. For example, when the wearable device 101 requires charging, it may emit red light at a constant cycle. In an embodiment, the light emitting module may be disposed on the first rim 201 and/or the second rim 202.

Referring to FIG. 2B, the wearable device 101 may include the printed circuit board (PCB) 290. The PCB 290 may be included in at least one of the first temple 204 or the second temple 205. The PCB 290 may include an interposer disposed between at least two sub PCBs. On the PCB 290, one or more hardware included in the wearable device 101 may be disposed. The wearable device 101 may include a flexible PCB (FPCB) for interconnecting the hardware.

According to an embodiment, the wearable device 101 may include at least one of a gyro sensor, a gravity sensor, and/or an acceleration sensor for detecting the posture of the wearable device 101 and/or the posture of a body part (e.g., a head) of the user wearing the wearable device 101. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 101 may identify the user’s motion and/or gesture performed to execute or stop a specific function of the wearable device 101 based on the IMU. FIGS. 2A and 2B are illustrated in a form such as the AR glasses, but are not limited thereto. For example, the wearable device 101 may include an HMD device and/or a video see-through (VST) device. The VST device may provide a UI for mixed reality (MR) based on a device worn on a user’s head, such as an HMD device.

FIG. 2C illustrates an example of a wearable device according to an embodiment.

Referring to FIG. 2C, an example of one or more hardware disposed in the wearable device 101 is illustrated. The wearable device 101 illustrated in FIG. 2C may be referred to as a head-wearable electronic device that may be worn on the user’s head. For example, the wearable device 101 illustrated in FIG. 2C may be described as a device in which the at least one display 230 and the at least one wave guide 233 and 234 and at least one optical device 282 and 284, associated with the at least one display 230, are omitted from the components of the wearable device described with reference to FIGS. 2A and 2B.

FIGS. 3A and 3B illustrate an example of a wearable device according to an embodiment.

Referring to FIG. 3A, an example of a first surface 310 of a housing included in the wearable device 101 is illustrated. Referring to FIG. 3B, an example of a second surface 320 opposite to the first surface 310 of the housing included in the wearable device 101 is illustrated.

Referring to FIG. 3A, the first surface 310 of the wearable device 101 may have an attachable shape on the user’s body part (e.g., the user’s face). The wearable device 101 may further include a strap for being fixed on the user’s body part, and/or one or more temples.

The wearable device 101 may include at least one display 330, a camera 340, and a depth sensor 350.

The at least one display 330 may include a first display 330-1 and a second display 330-2 disposed on the first surface 310. The first display 330-1 may output an image to a left eye among two eyes of the user, and the second display 330-2 may output an image to a right eye among two eyes of the user. The wearable device 101 may further include rubber or silicon packing, which are formed on the first surface 310, for preventing interference by light (e.g., ambient light) different from the light emitted from the first display 330-1 and the second display 330-2.

The camera 340 may include a camera 340-1, a camera 340-2, a camera 340-3, a camera 340-4, a camera 340-5, a camera 340-6, a camera 340-7, a camera 340-8, a camera 340-9, and a camera 340-10.

Referring to FIG. 3A, the wearable device 101 may include cameras 340-1 and 340-2 for photographing and/or tracking the user’s two eyes adjacent to each of the first display 330-1 and the second display 330-2. According to an embodiment, the wearable device 101 may include cameras 340-3 and 340-4 for photographing and/or recognizing a user’s face.

Referring to FIG. 3B, cameras 340-5, 340-6, 340-7, 340-8, 340-9, and a depth sensor 350 for obtaining information related to the external environment of the wearable device 101 may be disposed on the second surface 320 opposite to the first surface 310 of FIG. 3A. For example, camera 340-5, camera 340-6, camera 340-7, camera 340-8 may be disposed on the second surface 320 to recognize an external object different from the wearable device 101. For example, the wearable device 101 may obtain an image and/or video to be transmitted to each of the user’s two eyes, by using camera 340-9 and camera 340-10. The camera 340-9 may be disposed on the second surface 320 of the wearable device 101 to obtain an image to be displayed through the second display 330-2 corresponding to the right eye among two eyes of the user. The camera 340-10 may be disposed on the second surface 320 of the wearable device 101 to obtain an image to be displayed through the first display 330-1 corresponding to the left eye among two eyes of the user.

According to an embodiment, the depth sensor 350 may be disposed on the second surface 320 to identify a distance between the wearable device 101 and an external object. The wearable device 101 may obtain spatial information (e.g., a depth map) about at least a portion of the angle of view (FoV) of the user wearing the wearable device 101 by using the depth sensor 350.

A microphone for obtaining sound outputted from an external object may be disposed on the second surface 320 of the wearable device 101. The number of microphones may vary according to embodiments.

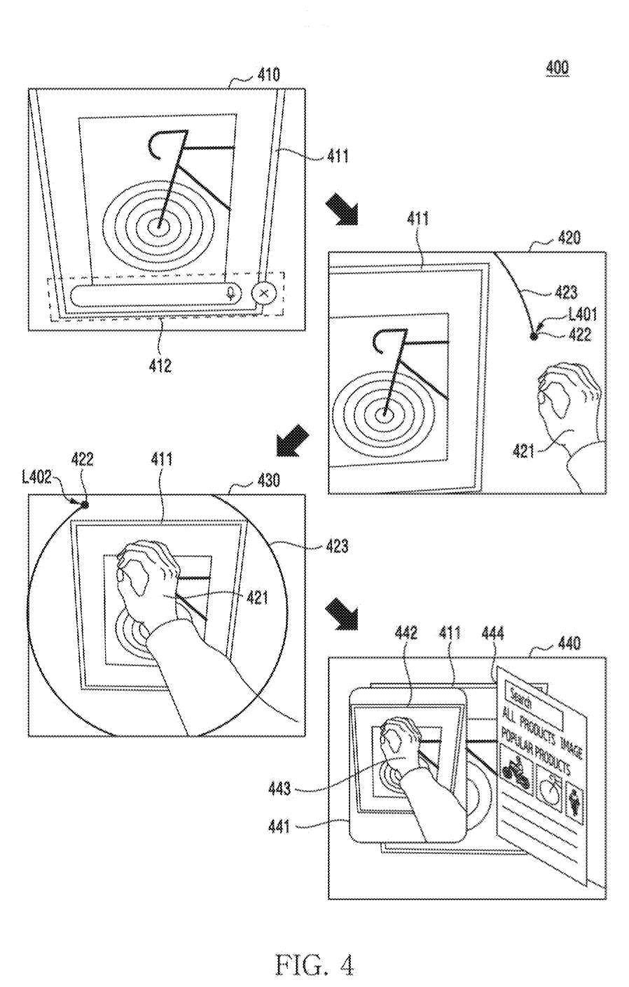

FIG. 4 illustrates an example of a usage environment of a wearable device to execute searching based on a gesture, according to an embodiment.

Referring to FIG. 4, a usage environment 400 of a wearable device 101 to execute searching based on a gesture is illustrated. In the usage environment 400, a user of the wearable device 101 may sequentially perceive visual information 410, visual information 420, visual information 430, and visual information 440 with a naked eye while a mode for searching based on the gesture is executed by the wearable device 101. According to various embodiments, the visual information 410, the visual information 420, the visual information 430, and the visual information 440 may be provided to the user’s naked eye via the wearable device 101 as augmented reality (AR), virtual reality (VR), or mixed reality (MR) in which augmented reality and virtual reality are mixed. However, the present disclosure is not limited thereto. For example, while the mode for searching based on the gesture is executed, the user of the wearable device 101 may perceive visual information of the real world with the naked eye without a visual effect displayed on a display of the wearable device 101.

The wearable device 101 may provide the mode for searching based on the gesture. For example, the mode may be described as a mode for executing a search function of application software (e.g., a web browser) for an image region of an image frame determined in accordance with a trajectory of an input object (e.g., the user’s hand or a controller for the wearable device 101) for a gesture. For example, the wearable device 101 may identify a trajectory of the gesture by detecting a movement of the input object for the gesture while the mode is executed. For example, the trajectory of the gesture may have various forms. For example, the trajectory of the gesture may correspond to a closed curve trajectory (e.g., a circular trajectory), a scribbling trajectory, or a linear trajectory. For example, the image frame for searching may be an image frame identified by at least one processor 110 among image frames captured via at least one camera 130 while the mode for searching based on the gesture is executed.

The wearable device 101 may receive a user input for executing the mode. The user input may be received via the wearable device 101 in various ways. For example, the user input may be an input in which a tangible button (e.g., a power button) of the wearable device 101 is pressed. For example, the user input may be an input for executing application software for the mode. For example, the user input may be an input based on a specified gesture.

For example, the user of wearable device 101 may perceive the visual information 410 with the naked eye when the wearable device 101 responds to the execution of the mode for searching based on the gesture. The visual information 410 may include an object 411 and a search bar 412. For example, the object 411 may be described as an object of interest for searching in the mode. For example, the search bar 412 may be described as a virtual search bar provided via the application software (e.g., the web browser) executed for searching in the mode. For example, the wearable device 101 may display the search bar 412 via at least one display 140 in response to the execution of the mode for searching based on the gesture.

The wearable device 101 may identify initiation of a gesture for searching via the input object, while the mode is executed. For example, the wearable device 101 may identify the initiation of the gesture for searching based on identifying a gesture of the input object (e.g., the user’s hand) corresponding to a pinch in gesture. For example, the wearable device 101 may identify the initiation of the gesture for searching based on a user input to the input object (e.g., the controller).

While the mode is executed, the wearable device 101 may identify the movement of the input object for the gesture via the at least one camera 130. For example, the input object may be described with one hand of the user of the wearable device 101. However, the present disclosure is not limited thereto. For example, the input object for the gesture may be an external electronic device (e.g., the controller) for controlling the wearable device 101. For example, while the mode is executed, the wearable device 101 may identify the movement of the input object (e.g., the controller) for the gesture via the at least one camera 130 or via communication circuitry 150 that supports communication with the input object. The wearable device 101 may display a virtual pointer indicating a location of the input object and a virtual trajectory indicating the movement path of the input object via the at least one display 140 while the input object is moved in the mode.

For example, when a location of an input object 421 corresponds to a location L401 in the mode, the user of the wearable device 101 may perceive the visual information 420 with the naked eye. The visual information 420 may include the object 411, the input object 421, a virtual pointer 422 indicating the location of the input object 421, and a virtual trajectory 423 indicating a movement path of the input object 421. For example, based on identifying the location of the input object 421 corresponding to the location L401 in the mode, the wearable device 101 may display, via the at least one display 140, the virtual pointer 422 indicating the location L401 and the virtual trajectory 423 indicating a movement path to the location L401.

For example, when the location of the input object 421 corresponds to a location L402 in the mode, the user of the wearable device 101 may perceive the visual information 430 with the naked eye. The visual information 430 may include the object 411, the input object 421, the virtual pointer 422, and the virtual trajectory 423. For example, based on identifying the location of the input object 421 corresponding to the location L402 in the mode, the wearable device 101 may display, via the at least one display 140, the virtual pointer 422 indicating the location L402 and the virtual trajectory 423 indicating a movement path to the location L402.

The wearable device 101 may identify completion of the gesture for searching while the mode is executed. For example, the wearable device 101 may identify the completion of the gesture for searching based on identifying a gesture of the input object (e.g., the user’s hand) corresponding to a pinch out gesture. For example, the wearable device 101 may identify the completion of the gesture for searching based on a user input to the input object (e.g., the controller).

In response to the completion of the gesture, the wearable device 101 may identify an image frame for searching among image frames captured via the at least one camera 130 while the mode is executed. In response to the completion of the gesture, the wearable device 101 may perform searching for an image region of the identified image frame determined in accordance with a trajectory of the gesture.

For example, when the wearable device 101 responds to the completion of the gesture, the user of the wearable device 101 may perceive the visual information 440 with the naked eye. The visual information 440 may include an object 411, a representation of a region 441 determined in accordance with the virtual trajectory 423, and a result 444 of searching for the region 441. The wearable device 101 may display the representation of the region 441 and the result 444 via the at least one display 140. For example, the region 441 may include a portion 442 corresponding to the object 411 and a portion 443 corresponding to the input object 421 for the gesture.

For example, as illustrated in FIG. 4, in a case that a search function is executed for the region 441 in which the portion 443 corresponding to the input object 421 is partially overlaid on the portion 442 corresponding to the object 411 for searching, accuracy of searching for the object 411 may be reduced. For example, unlike illustrated in FIG. 4, in a case that the wearable device 101 executes the search function using an image region in which the portion corresponding to the input object and the portion corresponding to the object for searching do not overlap each other, accuracy of searching for an object of interest may be increased. In the following description with reference to FIGS. 5 to 14, an operation method for increasing the accuracy of searching for the object of interest is described.

FIG. 5 illustrates an example of an environment to execute searching based on a gesture via a wearable device, according to an embodiment.

Referring to FIG. 5, a system 500 to execute searching based on a gesture via a wearable device 101 is illustrated. The system 500 may include a first camera 131, a second camera 132, at least one display 140, communication circuitry 150, at least one sensor 160, a system management unit 510, and a region selection unit 520. For example, at least a portion of components included in the system 500 may exchange a signal (e.g., a command or data) with each other.

The first camera 131 may be configured to capture images corresponding to a field of view (FoV) of a user wearing the wearable device 101. For example, the first camera 131 may be described as a camera (e.g., a high-resolution camera) configured to capture images for a pass-through mode. The second camera 132 may be configured to capture images for gesture recognition. For example, the second camera 132 may be described as a camera (e.g., a low-resolution camera) configured to capture images to identify a movement of an input object (e.g., the user’s hand or a controller for the wearable device 101) for a gesture. For example, the first camera 131 and the second camera 132 may be included in the at least one camera 130 of FIG. 1. For example, unlike illustrated in FIG. 5, the first camera 131 and the second camera 132 may be implemented as a single camera configured to capture images for the pass-through mode and the gesture recognition.

The system management unit 510 may include a head tracking module 511, a hand tracking module 512, a controller module 513, and a camera module 514. As a non-limiting example, the system management unit 510 may be described as system software (e.g., an operating system) executed by at least one processor 110 and stored in memory 120.

The head tracking module 511 may be described as software for identifying an orientation of the wearable device 101 based on sensing data obtained via the at least one sensor 160 (e.g., an acceleration sensor, a gyroscope sensor, and/or a gravity sensor). For example, the orientation of the wearable device 101 may be described as a location and a rotation angle of the wearable device 101 with respect to each of reference axes (e.g., an x-axis, a y-axis, and a z-axis).

The hand tracking module 512 may be described as software for identifying a location and/or the number of joints of the input object (e.g., the user’s hand) for the gesture based on an image captured via the at least one camera 130.

The controller module 513 may be described as software for identifying a location and/or a user input for the input object (e.g., the controller for the wearable device 101) for the gesture based on data obtained via the communication circuitry 150.

The camera module 514 may be described as software associated with the first camera 131 and/or the second camera 132. For example, the camera module 514 may be described as software to provide system software and/or application software with an image that combine s images obtained via the first camera 131 (e.g., a red, green, and blue (RGB) camera) and/or the second camera 132 (e.g., a red, green, and blue (RGB) camera).

The region selection unit 520 may include a pointer location determination module 521 and a selection region morphing module 522. For example, the region selection unit 520 may be described as software for determining a region of an image for searching based on a trajectory of the gesture for the gesture. As a non-limiting example, the region selection unit 520 may be described as application software executed by the at least one processor 110 and stored in the memory 120.

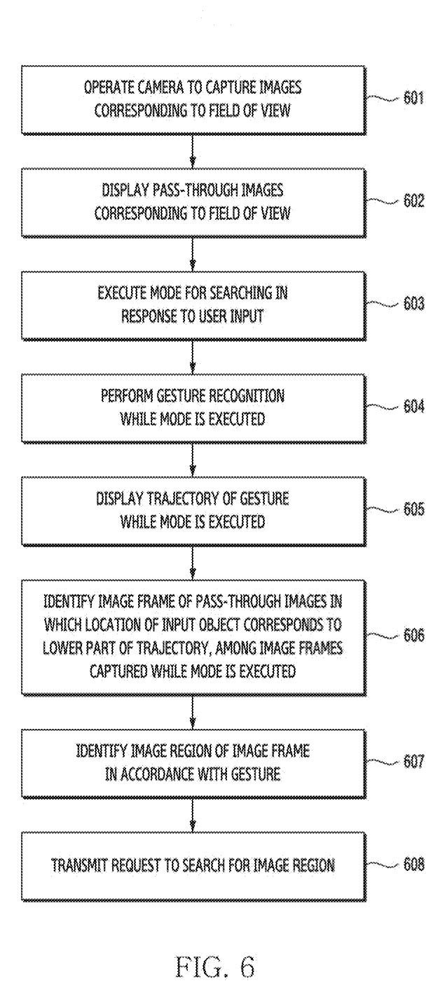

The pointer location determination module 521 may be described as software for determining a location (e.g., a height) of a virtual pointer corresponding to a location of the input object for the gesture via the at least one display 140. For example, the at least one processor 110 may identify an image frame captured via the at least one camera 130 as an image frame for searching based on identifying the location of the virtual pointer corresponding to the lowest location of the virtual pointer while a mode based on a gesture is executed, by using the pointer location determination module 521. For example, a size of a portion in which a region of an object of interest for searching and a region of the input object for the gesture are overlapped each other in an image frame that corresponds to the lowest location of the virtual pointer may be smaller than the size of the portion in which the region of the object of interest for searching and the region of the input object for the gesture are overlapped each other in an image frame that does not correspond to the lowest location of the virtual pointer. The at least one processor 110 may increase accuracy of searching based on the gesture by identifying an image frame corresponding to the lowest location of the input object for the gesture as an image frame for searching while the mode is executed. An operation method of identifying the image frame corresponding to the lowest location of the input object as the image frame for searching in the mode will be described later with reference to FIGS. 6 to 8.

The selection region morphing module 522 may be described as software for performing morphing, which corrects the image frame for searching based on a vector transformation in accordance with an orientation of the wearable device 101. For example, via the selection region morphing module 522, the at least one processor 110 may correct the image frame for searching based on an orientation of the wearable device 101 determined when storing the image frame for searching and an orientation of the wearable device 101 determined when responding to completion of the gesture. For example, in response to the completion of the gesture, the at least one processor 110 may determine an image region of an image frame corrected in accordance with the trajectory of the gesture and may perform searching for the image region of the corrected image frame. For example, the at least one processor 110 may increase the accuracy of searching based on the gesture even when the orientation of the wearable device 101 is changed while a mode for searching based on the gesture is executed, by correcting the image frame for searching in accordance with the orientation of the wearable device 101.

FIG. 6 is a flowchart illustrating a method of identifying an image frame for searching among image frames captured via a camera based on a location of a trajectory for a gesture, according to an embodiment.

Referring to FIG. 6, in operation 601, at least one processor 110 may operate at least one camera 130 (e.g., a first camera 131) to capture images. For example, the at least one processor 110 may capture images corresponding to a field of view (FoV) of a user wearing a wearable device 101 via the first camera 131. For example, the first camera 131 may be described as a camera (e.g., a high-resolution camera) used to provide a pass-through mode in which the images corresponding to the field of view of the user are displayed via at least one display 140.

In operation 602, the at least one processor 110 may display, via the at least one display 140, pass-through images corresponding to the field of view of the user based on at least a portion of images captured via the at least one camera 130 (e.g., the first camera 131). For example, the pass-through images may correspond to image frames obtained via the at least one camera 130.

In operation 603, the at least one processor 110 may execute a mode for searching based on a gesture in response to a user input. For example, the mode may be described as a mode (e.g., a circle-to-search mode) for executing a search function of application software (e.g., a web browser) for an image region determined by a trajectory of the gesture. The at least one processor 110 may receive a user input for executing the mode. For example, the user input may be an input in which a tangible button (e.g., a power button) of the wearable device 101 is pressed. For example, the user input may be an input for executing the application software for the mode. For example, the user input may be an input based on a specified gesture. For example, the gesture may be described as a movement of the user’s body to manipulate the wearable device or a movement of an object in accordance with the movement of the user’s body to manipulate the wearable device.

In operation 604, the at least one processor 110 may perform gesture recognition to identify the gesture, while the mode is executed. For example, while the mode is executed, the at least one processor 110 may perform the gesture recognition using images obtained via the at least one camera 130 (e.g., a second camera 132). For example, the second camera 132 may be described as a camera (e.g., a low-resolution camera) used to capture images for the gesture recognition. For example, while the mode is executed, the at least one processor 110 may perform the gesture recognition using the at least one camera 130 (e.g., the second camera 132) to identify a location of an input object (e.g., the user’s hand or a controller for the wearable device 101) for the gesture. However, the present disclosure is not limited thereto. For example, while the mode is executed, the at least one processor 110 may identify the location of the input object by receiving location data on the input object (e.g., the controller for the wearable device 101) from the input object via communication circuitry 150.

In operation 605, the at least one processor 110 may display the trajectory of the gesture while the mode is executed. For example, the trajectory of the gesture may be described as a trajectory of the input object (e.g., the user’s hand or the controller for the wearable device 101) indicating a movement path of the input object for the gesture. The trajectory may include a first portion (e.g., a lower part) of the gesture and a second portion (e.g., an upper part) of the gesture. The location of the input object in the first portion of the trajectory may be below the location of the input object in the second portion of the trajectory. Distinguishing the first portion of the trajectory and the second portion of the trajectory may be described in various ways according to an embodiment. As a non-limiting example, the at least one processor 110 may divide the trajectory into the first portion and the second portion in accordance with a reference line between the highest location of the trajectory and the lowest location of the trajectory. For example, the reference line may vary in accordance with a location of an object of interest included in an image frame captured via the at least one camera 130.

In operation 606, the at least one processor 110 may identify an image frame of pass-through images in which the location of the input object corresponds to the first portion (e.g., the lower part) of the trajectory, among image frames captured while the mode is executed. For example, the image frames may be described as image frames captured via the at least one camera 130 (e.g., the first camera 131 and/or the second camera 132) while the mode is executed. For example, the image frames may each correspond to pass-through images displayed via the at least one display 140 while the mode is executed. For example, the at least one processor 110 may identify an image frame for a pass-through image corresponding to the lowest location of the input object among the pass-through images corresponding to the first portion of the trajectory as an image frame for searching. For example, in accordance with the location of the input object, the at least one processor 110 may store one or more image frames among the image frames captured via the at least one camera 130 in buffer memory of the at least one camera 130 or non-volatile memory of the wearable device 101. For example, in response to completion of the gesture, the at least one processor 110 may identify the image frame of the pass-through image corresponding to the lowest location of the input object among the image frames stored in the buffer memory or the non-volatile memory as the image frame for searching. For example, the image frame for searching may be described as an image frame stored when the location of the input object is lowest while the mode is executed.

According to an embodiment, while the mode is executed, the at least one processor 110 may store location data indicating the location of the input object in accordance with a movement of the input object. For example, the at least one processor 110 may identify the lowest location of the input object indicated in accordance with the location data. For example, while the mode is executed, the at least one processor 110 may store one or more image frames among the image frames captured via the at least one camera 130 (e.g., the first camera 131 and/or the second camera 132) while the mode is executed, based on the location (e.g., a current location) of the input object lower than the lowest location of the input object indicated in accordance with the location data.

According to an embodiment, while the mode is executed, the at least one processor 110 may determine whether to store the image frame captured via the at least one camera 130 in accordance with the location of the input object. For example, while the mode is executed, the at least one processor 110 may store the location data indicating the location of the input object in accordance with the movement of the input object. For example, the at least one processor 110 may identify the lowest location of the input object indicated in accordance with the location data. For example, the at least one processor 110 may store the image frame captured via the at least one camera 130 when the location of the input object corresponds to a first location (e.g., the lowest location). For example, the first location may be described as the lowest location of the input object indicated in accordance with the location data on the input object. For example, when the location of the input object corresponds to a second location (e.g., the current location) lower than the first location, the at least one processor 110 may store the image frame captured via the at least one camera 130 and determine (or update) the second location as the first location. For example, when the location of the input object corresponds to a third location (e.g., the current location) above the first location, the at least one processor 110 may refrain from storing the image frame captured via the at least one camera 130.

According to an embodiment, while the mode is executed, the at least one processor 110 may identify the lowest location of the input object in accordance with the movement of the input object via the at least one camera 130 (e.g., the second camera 132). For example, the at least one processor 110 may store the image frame captured via the at least one camera 130 based on identifying the lowest location of the input object. For example, a time point when the image frame is stored may be described in various ways according to an embodiment. For example, the at least one processor 110 may identify the lowest location of the input object at an inflection point of the trajectory of the gesture and may store the image frame captured via the at least one camera 130 at the location of the input object higher than the inflection point.

In operation 607, in response to the completion of the gesture, the at least one processor 110 may identify an image region of the image frame for searching in accordance with the gesture. For example, when the gesture is completed, the image region may be described as a region corresponding to the trajectory of the gesture in the image frame. For example, the image region may include an object of interest corresponding to the trajectory of the gesture among one or more objects included in the image frame for searching.

In operation 608, the at least one processor 110 may transmit a request to execute searching for the image region of the image frame for searching to an external electronic device (e.g., a server 1508). For example, the at least one processor 110 may execute the search function of the application software (e.g., the web browser) for the image region, in order to transmit the request to search for the image region in response to the completion of the gesture. For example, in response to the completion of the gesture, the at least one processor 110 may display a representation of the image region of the corrected image frame and a result of searching for the image region via the at least one display 140. For example, the at least one processor 110 may increase accuracy of searching based on the gesture by identifying the image frame corresponding to the lowest location of the input object for the gesture as the image frame for searching.

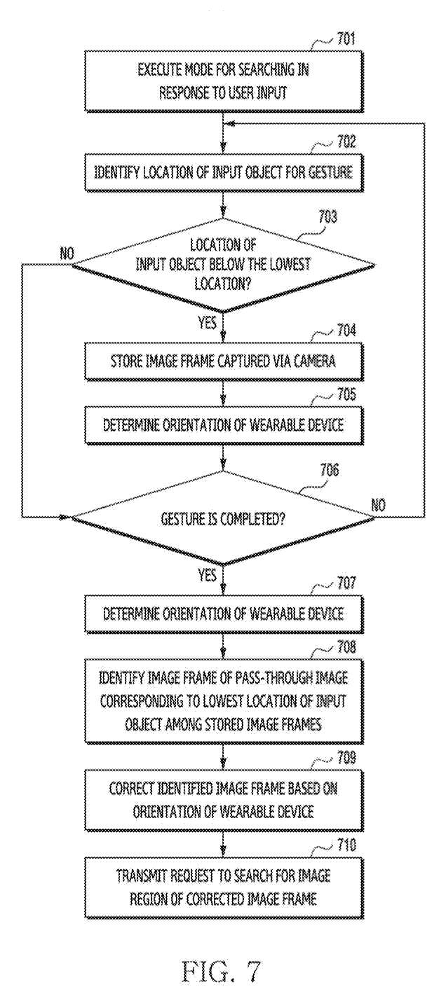

FIG. 7 is a flowchart illustrating a method of correcting an image frame for searching identified based on a location of a trajectory for a gesture in accordance with an orientation of a wearable device, according to an embodiment.

Referring to FIG. 7, in operation 701, at least one processor 110 may execute a mode for searching based on a gesture in response to a user input. For example, the mode may be described as a mode (e.g., a circle-to-search mode) for executing a search function of application software (e.g., a web browser) for an image region determined by a trajectory of the gesture. The at least one processor 110 may receive a user input for executing the mode. For example, the user input may be an input in which a tangible button (e.g., a power button) of a wearable device 101 is pressed. For example, the user input may be an input for executing the application software for the mode. For example, the user input may be an input based on a specified gesture. For example, the mode may be executed in a state in which at least one camera 130 (e.g., a first camera 131) is operated to display pass-through images corresponding to a field of view (FoV) of a user. For example, the pass-through images may correspond to image frames obtained via the at least one camera 130. For example, while the mode is executed, the at least one processor 110 may display the trajectory of the gesture indicating a movement path of the input object via at least one display 140. For example, the gesture may be described as a movement of the user’s body to manipulate the wearable device or a movement of an object in accordance with the movement of the user’s body to manipulate the wearable device.

In operation 702, while the mode is executed, the at least one processor 110 may perform gesture recognition using images obtained via the at least one camera 130 (e.g., a second camera 132) to identify a location of an input object (e.g., the user’s hand or a controller for the wearable device 101) for the gesture. However, the present disclosure is not limited thereto. For example, while the mode is executed, the at least one processor 110 may identify the location of the input object by receiving location data on the input object (e.g., the controller for the wearable device 101) from the input object via communication circuitry 150. For example, the at least one processor 110 may store the location data indicating the location of the input object.

In operation 703, the at least one processor 110 may determine whether the location (e.g., a current location) of the input object is lower than the lowest location of the input object in accordance with the location data based on identifying the location of the input object. For example, the at least one processor 110 may perform operation 706 in accordance with determination that the location of the input object is above the lowest location of the input object indicated in accordance with the location data (e.g., in a case of NO of the operation 703). For example, the at least one processor 110 may perform operation 704 and operation 705 sequentially or in parallel in accordance with determination that the location of the input object is below the lowest location of the input object indicated in accordance with the location data (e.g., in a case of YES of the operation 703).

In the operation 704, in accordance with determination that the location of the input object is below the lowest location of the input object indicated in accordance with the location data (e.g., in a case of YES of the operation 703), the at least one processor 110 may store image frames captured via the at least one camera 130 (e.g., the first camera 131 and/or the second camera 132) when identifying the location of the input object, in buffer memory of the at least one camera 130 or non-volatile memory of the wearable device 101.

In the operation 705, in accordance with the determination that the location of the input object is lower than the lowest location of the input object indicated in accordance with the location data (e.g., in a case of YES of the operation 703), the at least one processor 110 may determine an orientation of the wearable device 101 when identifying the location of the input object, via at least one sensor 160. For example, the at least one processor 110 may store orientation data indicating the orientation of the wearable device 101.

In the operation 706, the at least one processor 110 may determine whether a gesture for searching has been completed. For example, the at least one processor 110 may identify the completion of the gesture for searching based on identifying a gesture of the input object (e.g., the user’s hand) corresponding to a pinch out gesture. For example, the at least one processor 110 may identify the completion of the gesture for searching based on a user input to the input object (e.g., the controller). For example, the at least one processor 110 may perform the operation 702 in accordance with determination that the gesture has not been completed (e.g., in a case of NO of the operation 706). For example, the at least one processor 110 may perform operation 707 and operation 708 sequentially or in parallel in accordance with the determination that the gesture has been completed (e.g., in a case of YES of the operation 706).

In the operation 707, in response to the completion of the gesture (e.g., in a case of YES of the operation 706), the at least one processor 110 may determine the orientation of the wearable device 101 via the at least one sensor 160. For example, the orientation of the wearable device 101 may be described as a location and a rotation angle of the wearable device 101 with respect to each of reference axes (e.g., an x-axis, a y-axis, and a z-axis). For example, the at least one processor 110 may store the orientation data indicating the orientation of the wearable device 101.

In the operation 708, in response to the completion of the gesture (e.g., in a case of YES of the operation 706), the at least one processor 110 may identify an image frame of a pass-through image corresponding to the lowest location of the input object indicated in accordance with the location data among the image frames stored in the buffer memory or the non-volatile memory as an image frame for searching.

In operation 709, the at least one processor 110 may correct the identified image frame based on the orientation of the wearable device 101. For example, the at least one processor 110 may correct the identified image frame based on a first orientation and a second orientation of the wearable device 101. For example, the first orientation may be an orientation of the wearable device 101 determined by the at least one processor 110 when the image frame corresponding to the lowest location of the input object is captured. For example, the second orientation may be an orientation of the wearable device 101 determined by the at least one processor 110 when the at least one processor 110 responds to the completion of the gesture. For example, the at least one processor 110 may correct the identified image frame based on a vector transformation from the first orientation to the second orientation.

In operation 710, in response to the completion of the gesture, the at least one processor 110 may transmit a request to search for an image region of the corrected image frame to an external electronic device (e.g., a server 1508). For example, in response to the completion of the gesture, the at least one processor 110 may identify the image region of the corrected image frame in accordance with the gesture. For example, when the gesture is completed, the image region may be described as a region corresponding to the trajectory of the gesture in the image frame. For example, the image region may include an object of interest corresponding to the trajectory of the gesture among one or more objects included in the image frame for searching. For example, the at least one processor 110 may execute the search function of the application software (e.g., the web browser) for the image region to transmit the request to search for the image region of the corrected image frame in response to the completion of the gesture. For example, in response to the completion of the gesture, the at least one processor 110 may display a representation of the image region of the corrected image frame and a result of searching for the image region via the at least one display 140. For example, the at least one processor 110 may increase accuracy of searching based on the gesture by identifying the image frame corresponding to the lowest location of the input object for the gesture while the mode is executed as the image frame for searching.

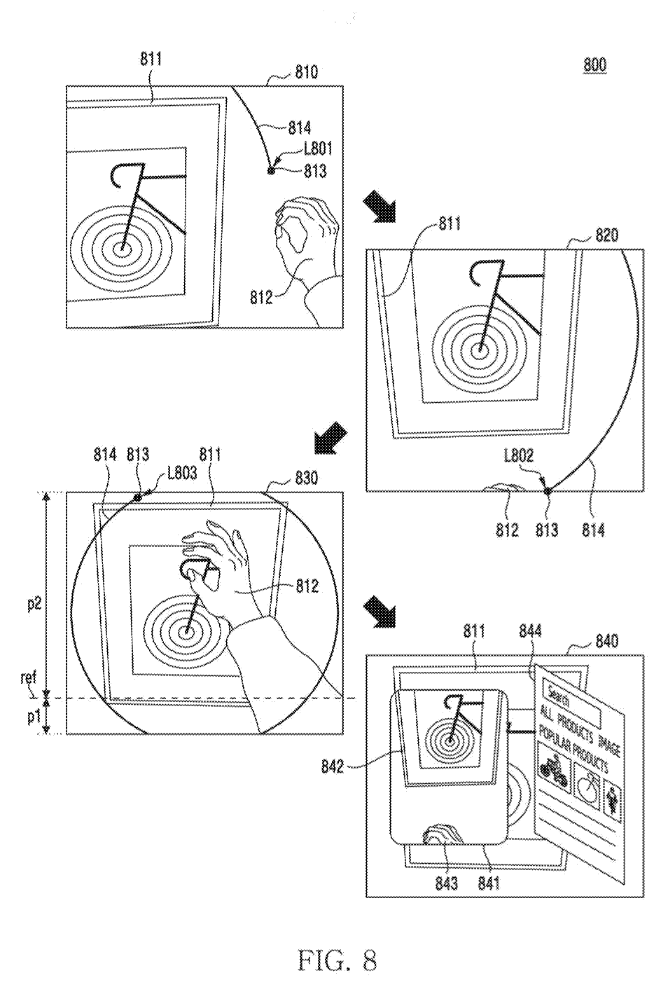

FIG. 8 is an example of a usage environment of a wearable device to execute searching for an image frame corresponding to the lowest location of an input object for a gesture, according to an embodiment.

Referring to FIG. 8, a usage environment 800 of a wearable device 101 to execute searching based on a gesture is illustrated. In the usage environment 800, a user of the wearable device 101 may sequentially perceive visual information 810, visual information 820, visual information 830, and visual information 840 with a naked eye while a mode for searching based on the gesture is executed by the wearable device 101. According to various embodiments, the visual information 810, the visual information 820, the visual information 830, and the visual information 840 may be provided to the user’s naked eye via the wearable device 101 as augmented reality (AR), virtual reality (VR), or mixed reality (MR) in which augmented reality and virtual reality are mixed. However, the present disclosure is not limited thereto. For example, while the mode for searching based on the gesture is executed, the user of the wearable device 101 may perceive visual information of the real world with the naked eye without a visual effect displayed on a display of the wearable device 101.

While the mode is executed, the wearable device 101 may store location data indicating a location of an input object for a gesture. While the mode is executed, at the location of the input object lower than the lowest location of the input object indicated in accordance with the location data, the wearable device 101 may store an image frame captured via at least one camera 130 and may store orientation data indicating an orientation of the wearable device 101.

For example, when a location of an input object 812 corresponds to a location L801 in the mode, the user of the wearable device 101 may perceive the visual information 810 with the naked eye. The visual information 810 may include an object 811, an input object 812 , a virtual pointer 813 indicating the location of the input object 812, and a virtual trajectory 814 indicating a movement path of the input object 812. For example, based on identifying the location of the input object 812 corresponding to the location L801 in the mode, the wearable device 101 may display, via at least one display 140, the virtual pointer 813 indicating the location L801 and the virtual trajectory 814 indicating a movement path to the location L801. For example, the wearable device 101 may store an image frame corresponding to the visual information 810 and the orientation data indicating the orientation of the wearable device 101 based on identification of the location L801 lower than the lowest location of the input object 812 indicated in accordance with location data on the input object 812.

For example, when the location of the input object 812 corresponds to a location L802 in the mode, the user of the wearable device 101 may perceive the visual information 820 with the naked eye. The visual information 820 may include the object 811, the input object 812, the virtual pointer 813 indicating the location of the input object 812, and the virtual trajectory 814 indicating the movement path of the input object 812. For example, based on identifying the location of the input object 812 corresponding to the location L802 in the mode, the wearable device 101 may display, via the at least one display 140, the virtual pointer 813 indicating the location L802 and the virtual trajectory 814 indicating a movement path to the location L802. For example, the wearable device 101 may store an image frame corresponding to the visual information 820 and the orientation data indicating the orientation of the wearable device 101 based on identification of the location L802 lower than the lowest location of the input object 812 indicated in accordance with the location data on the input object 812.

For example, when the location of the input object 812 corresponds to a location L803 in the mode, the user of the wearable device 101 may perceive the visual information 830 with the naked eye. The visual information 830 may include the object 811, the input object 812 , the virtual pointer 813 indicating the location of the input object 812, and the virtual trajectory 814 indicating the movement path of the input object 812. For example, based on identifying the location of the input object 812 corresponding to the location L803 in the mode, the wearable device 101 may display, via the at least one display 140, the virtual pointer 813 indicating the location L803 and the virtual trajectory 814 indicating a movement path to the location L803. For example, the wearable device 101 may refrain from storing an image frame corresponding to the visual information 830 based on identification of the location L803 higher than the lowest location (e.g., the location L802) of the input object 812 indicated in accordance with the location data on the input object 812. For example, the virtual trajectory 814 may include a first portion p1 of the gesture and a second portion p2 of the gesture. The location of the input object 812 in the first portion p1 of the virtual trajectory 814 may be lower than the location of the input object 812 in the second portion p2 of the virtual trajectory 814. Distinguishing the first portion p1 of the virtual trajectory 814 and the second portion p2 of the virtual trajectory 814 may be described in various ways according to an embodiment. As a non-limiting example, the wearable device 101 may divide the virtual trajectory 814 into the first portion p1 and the second portion p2 in accordance with a reference line ref between the highest location of the virtual trajectory 814 and the lowest location of the virtual trajectory 814. For example, the reference line ref may vary in accordance with a location of the object 811 of interest included in the image frame (e.g., an image corresponding to the visual information 830) captured via the at least one camera 130. The wearable device 101 may store the orientation data indicating the orientation of the wearable device 101 in response to completion of the gesture. In response to the completion of the gesture, the wearable device 101 may identify an image frame (e.g., an image frame corresponding to the lowest location of the input object 812) of pass-through images corresponding to a first portion p1 (e.g., a lower part) of a virtual trajectory 814 among the stored image frames as an image frame for searching. In response to the completion of the gesture, the wearable device 101 may correct the identified image frame based on the orientation data. In response to the completion of the gesture, the wearable device 101 may perform searching for an image region of the corrected image frame determined in accordance with a trajectory of the gesture.

For example, the user of the wearable device 101 may perceive the visual information 840 with the naked eye when the wearable device 101 responds to the completion of the gesture. The visual information 840 may include the object 811, a representation of a region 841 determined in accordance with the virtual trajectory 814, and a result 844 of searching for the region 841. For example, the wearable device 101 may display, via the at least one display 140, the representation of the region 841 and the result 844. For example, the region 841 may include a portion 842 corresponding to the object 811 and a portion 843 corresponding to the input object 812 for a gesture. For example, in response to the completion of the gesture, the wearable device 101 may identify an image frame (e.g., an image frame corresponding to the visual information 820) corresponding to the lowest location L802 among the stored image frames as an image frame for searching. For example, the wearable device 101 may correct the image frame corresponding to the lowest location L802 based on a vector transformation from the orientation of the wearable device 101 corresponding to the visual information 820 to the orientation of the wearable device 101 corresponding to the visual information 830. For example, the region 841 may be described as an image region of the corrected image frame determined in accordance with the virtual trajectory 814.

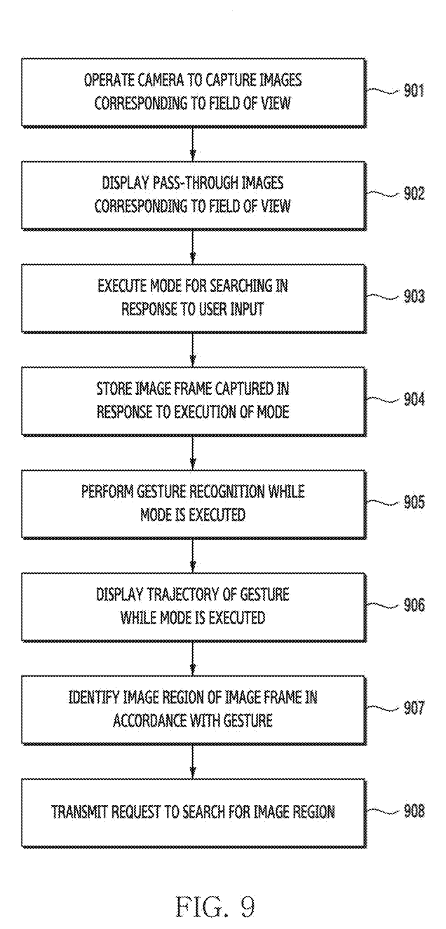

FIG. 9 is a flowchart illustrating a method of identifying an image frame captured via a camera as an image frame for searching in response to execution of a mode for searching based on a gesture, according to an embodiment.

Referring to FIG. 9, in operation 901, at least one processor 110 may operate at least one camera 130 (e.g., a first camera 131) to capture images. For example, the at least one processor 110 may capture images corresponding to a field of view (FoV) of a user wearing a wearable device 101 via the first camera 131. For example, the first camera 131 may be described as a camera (e.g., a high-resolution camera) used to provide a pass-through mode in which the images corresponding to the field of view of the user are displayed via at least one display 140.

In operation 902, the at least one processor 110 may display, via the at least one display 140, pass-through images corresponding to the field of view of the user, based on at least a portion of the images captured via the at least one camera 130 (e.g., the first camera 131). For example, the pass-through images may correspond to image frames obtained via the at least one camera 130.

In operation 903, the at least one processor 110 may execute a mode for searching based on a gesture in response to a user input. For example, the mode may be described as a mode (e.g., a circle-to-search mode) to execute a search function of application software (e.g., a web browser) for an image region of an image frame determined in accordance with a trajectory of the gesture. The at least one processor 110 may receive the user input for executing the mode. For example, the user input may be an input in which a tangible button (e.g., a power button) of the wearable device 101 is pressed. For example, the user input may be an input for executing the application software for the mode. For example, the user input may be an input based on a specified gesture. For example, the gesture may be described as a movement of the user’s body to manipulate the wearable device or a movement of an object in accordance with the movement of the user’s body to manipulate the wearable device.

In operation 904, in response to the execution of the mode, the at least one processor 110 may store an image frame captured via the least one camera 130 (e.g., the first camera 131 and/or a second camera 132) in buffer memory of the at least one camera 130 or non-volatile memory of the wearable device 101.

In operation 905, the at least one processor 110 may perform gesture recognition to identify the gesture, while the mode is executed. For example, while the mode is executed, the at least one processor 110 may perform the gesture recognition using the images obtained via the at least one camera 130 (e.g., the second camera 132). For example, the second camera 132 may be described as a camera (e.g., a low-resolution camera) used to capture images for the gesture recognition. For example, while the mode is executed, the at least one processor 110 may perform the gesture recognition using the at least one camera 130 (e.g., the second camera 132) to identify a location of an input object (e.g., the user’s hand or a controller for the wearable device 101) for the gesture. However, the present disclosure is not limited thereto. For example, while the mode is executed, the at least one processor 110 may identify the location of the input object by receiving location data on the input object (e.g., the controller for the wearable device 101) from the input object via communication circuitry 150.

In operation 906, the at least one processor 110 may display the trajectory of the gesture while the mode is executed. For example, the trajectory of the gesture may be described as a trajectory of the input object (e.g., the user’s hand or the controller for the wearable device 101) indicating a movement path of the input object for the gesture.

In operation 907, in response to completion of the gesture, the at least one processor 110 may identify an image region of an image frame for searching in accordance with the gesture. For example, when the gesture is completed, the image region may be described as a region corresponding to the trajectory of the gesture in the image frame. For example, the image region may include an object of interest corresponding to the trajectory of the gesture among one or more objects included in the image frame for searching.

In operation 908, the at least one processor 110 may transmit a request to execute searching for the image region of the image frame for searching to an external electronic device (e.g., a server 1508). For example, the at least one processor 110 may execute the search function of the application software (e.g., the web browser) for the image region, in order to transmit the request to search for the image region in response to the completion of the gesture. For example, in response to the completion of the gesture, the at least one processor 110 may display a representation of the image region of the corrected image frame and a result of searching for the image region via the at least one display 140. For example, since the image frame stored in response to the execution of the mode does not include a region of the input object, the at least one processor 110 may increase accuracy of searching based on the gesture by identifying the image frame stored in response to the execution of the mode as the image frame for searching.

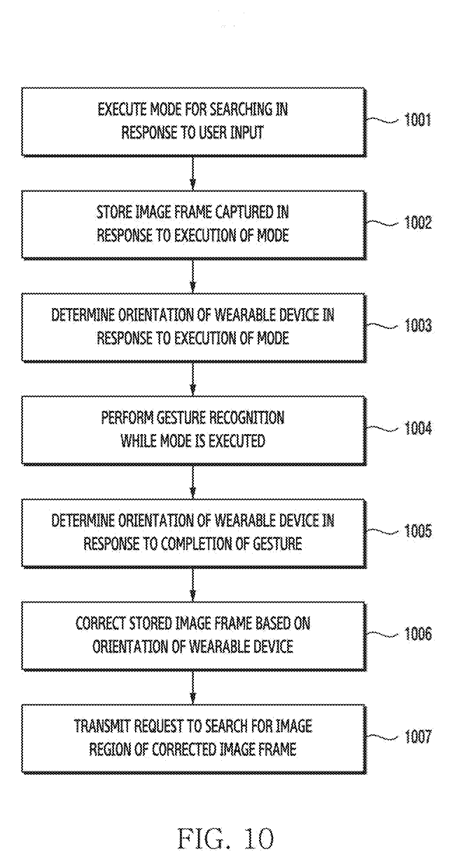

FIG. 10 is a flowchart illustrating a method of correcting an image frame for searching identified in response to execution of a mode for searching based on a gesture in accordance with an orientation of a wearable device, according to an embodiment.

Referring to FIG. 10, in operation 1001, at least one processor 110 may execute a mode for searching based on a gesture in response to a user input. For example, the mode may be described as a mode for executing a search function of application software (e.g., a web browser) for an image region of an image frame determined by a trajectory of the gesture. The at least one processor 110 may receive a user input for executing the mode. For example, the user input may be an input in which a tangible button (e.g., a power button) of a wearable device 101 is pressed. For example, the user input may be an input for executing the application software for the mode. For example, the user input may be an input based on a specified gesture. For example, the mode may be executed in a state in which at least one camera 130 (e.g., a first camera 131) is operated to display pass-through images corresponding to a field of view (FoV) of a user. For example, the pass-through images may correspond to image frames obtained via the at least one camera 130. For example, while the mode is executed, the at least one processor 110 may display the trajectory of the gesture indicating a movement path of the input object via at least one display 140. For example, the gesture may be described as a movement of the user’s body to manipulate the wearable device or a movement of an object in accordance with the movement of the user’s body to manipulate the wearable device.

In operation 1002, in response to the execution of the mode, the at least one processor 110 may store an image frame captured via the least one camera 130 (e.g., the first camera 131 and/or a second camera 132) in buffer memory of the at least one camera 130 or non-volatile memory of the wearable device 101.

In operation 1003, in response to the execution of the mode, the at least one processor 110 may determine an orientation of the wearable device 101 via at least one sensor 160. For example, the orientation of the wearable device 101 may be described as a location and a rotation angle of the wearable device 101 with respect to each of reference axes (e.g., an x-axis, a y-axis, and a z-axis). For example, the at least one processor 110 may store orientation data indicating the orientation of the wearable device 101.

In operation 1004, while the mode is executed, the at least one processor 110 may perform gesture recognition using images obtained via the at least one camera 130 (e.g., the second camera 132) to identify a location of an input object (e.g., the user’s hand or a controller for the wearable device 101) for the gesture. However, the present disclosure is not limited thereto. For example, while the mode is executed, the at least one processor 110 may identify the location of the input object by receiving location data on the input object (e.g., the controller for the wearable device 101) from the input object via communication circuitry 150.

In operation 1005, in response to completion of the gesture, the at least one processor 110 may determine the orientation of the wearable device 101 via the at least one sensor 160. For example, the at least one processor 110 may store the orientation data indicating the orientation of the wearable device 101.

In operation 1006, the at least one processor 110 may correct the stored image frame based on the orientation of the wearable device 101. For example, the at least one processor 110 may correct the stored image frame based on a first orientation and a second orientation of the wearable device 101. For example, the first orientation may be an orientation of the wearable device 101 determined by the at least one processor 110 when the image frame is stored in response to the execution of the mode. For example, the second orientation may be an orientation of the wearable device 101 determined by the at least one processor 110 when the at least one processor 110 responds to the completion of the gesture. For example, the at least one processor 110 may correct the stored image frame based on a vector transformation from the first orientation to the second orientation.

In operation 1007, in response to the completion of the gesture, the at least one processor 110 may transmit a request to search for an image region of the corrected image frame to an external electronic device (e.g., a server 1508). For example, in response to the completion of the gesture, the at least one processor 110 may identify the image region of the corrected image frame in accordance with the gesture. For example, when the gesture is completed, the image region may be described as a region corresponding to the trajectory of the gesture in the image frame. For example, the image region may include an object of interest corresponding to the trajectory of the gesture among one or more objects included in the image frame for searching. For example, the at least one processor 110 may execute the search function of the application software (e.g., the web browser) for the image region to transmit the request to search for the image region of the corrected image frame in response to the completion of the gesture. For example, in response to the completion of the gesture, the at least one processor 110 may display a representation of the image region of the corrected image frame and a result of searching for the image region via the at least one display 140. For example, the at least one processor 110 may increase accuracy of searching based on the gesture by identifying the image frame stored in response to the execution of the mode as the image frame for searching.

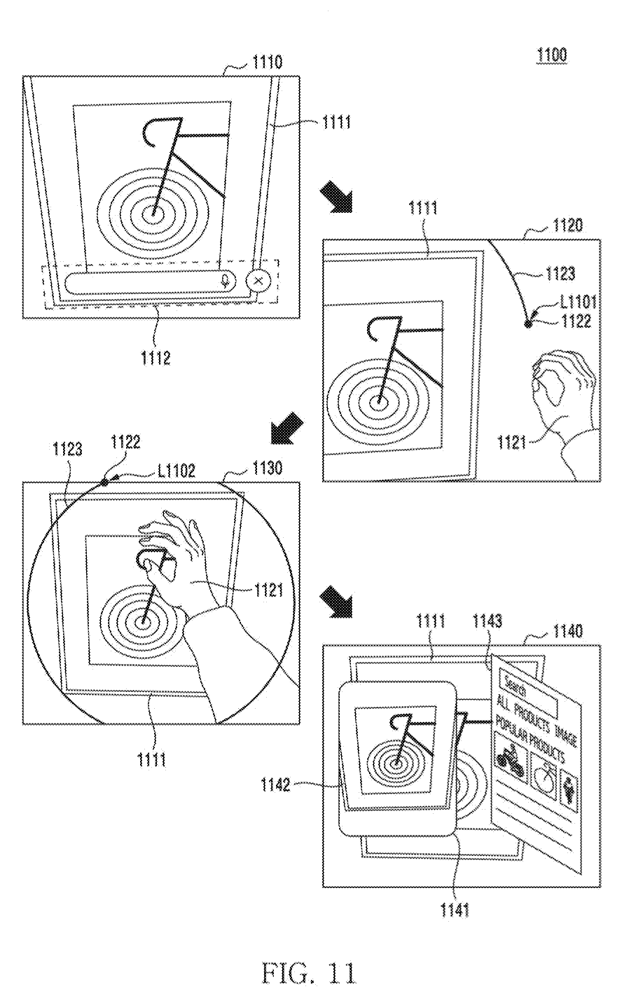

FIG. 11 is an example of a usage environment of a wearable device to execute searching for an image frame stored in response to execution of a mode for searching based on a gesture, according to an embodiment.

Referring to FIG. 11, a usage environment 1100 of a wearable device 101 to execute searching based on a gesture is illustrated. In the usage environment 1100, a user of the wearable device 101 may sequentially perceive visual information 1110, visual information 1120, visual information 1130, and visual information 1140 with a naked eye while a mode for searching based on the gesture is executed by the wearable device 101. According to various embodiments, the visual information 1110, the visual information 1120, the visual information 1130, and the visual information 1140 may be provided to the user’s naked eye via the wearable device 101 as augmented reality (AR), virtual reality (VR), or mixed reality (MR) in which augmented reality and virtual reality are mixed. However, the present disclosure is not limited thereto. For example, while the mode for searching based on the gesture is executed, the user of the wearable device 101 may perceive visual information of the real world with the naked eye without a visual effect displayed on a display of the wearable device 101.

The wearable device 101 may receive a user input for executing the mode. The user input may be received via the wearable device 101 in various ways. For example, the user input may be an input in which a tangible button (e.g., a power button) of the wearable device 101 is pressed. For example, the user input may be an input for executing application software for the mode. For example, the user input may be an input based on a specified gesture.

For example, the user of wearable device 101 may perceive the visual information 1110 with the naked eye when the wearable device 101 responds to the execution of the mode. The visual information 1110 may include an object 1111 and a search bar 1112. For example, the object 1111 may be described as an object of interest for searching in the mode. For example, the search bar 1112 may be described as a virtual search bar provided via application software (e.g., a web browser) executed for searching in the mode. For example, the wearable device 101 may display the search bar 1112 via at least one display 140 in response to the execution of the mode for searching based on the gesture. For example, in response to the execution of the mode, the wearable device 101 may store an image frame corresponding to the visual information 1110 and orientation data indicating an orientation of the wearable device 101.

For example, when a location of an input object 1121 corresponds to a location L1101 in the mode, the user of the wearable device 101 may perceive the visual information 1120 with the naked eye. The visual information 1120 may include the object 1111, the input object 1121, a virtual pointer 1122 indicating the location of the input object 1121, and a virtual trajectory 1123 indicating a movement path of the input object 1121. For example, based on identifying the location of the input object 1121 corresponding to the location L1101 in the mode, the wearable device 101 may display, via the at least one display 140, the virtual pointer 1122 indicating the location L1101 and the virtual trajectory 1123 indicating a movement path to the location L1101.

For example, when the location of the input object 1121 corresponds to a location L1102 in the mode, the user of the wearable device 101 may perceive the visual information 1130 with the naked eye. The visual information 1130 may include the object 1111, the input object 1121, the virtual pointer 1122, and the virtual trajectory 1123. For example, based on identifying the location of the input object 1121 corresponding to the location L1102 in the mode, the wearable device 101 may display, via the at least one display 140, the virtual pointer 1122 indicating the location L1102 and the virtual trajectory 1123 indicating a movement path to the location L1102.

In response to completion of the gesture, the wearable device 101 may store the orientation data indicating the orientation of the wearable device 101. In response to the completion of the gesture, the wearable device 101 may identify the stored image frame as an image frame for searching when the mode is executed. In response to the completion of the gesture, the wearable device 101 may correct the identified image frame based on the orientation data. In response to the completion of the gesture, the wearable device 101 may perform searching for an image region of the corrected image frame determined in accordance with a trajectory of the gesture.

For example, the user of the wearable device 101 may perceive the visual information 1140 with the naked eye when the wearable device 101 responds to the completion of the gesture. The visual information 1140 may include the object 1111, a representation of a region 1141 determined in accordance with the virtual trajectory 1123, and a result 1143 of searching for the region 1141. The wearable device 101 may display, via the at least one display 140, the representation of the region 1141 and the result 1143. For example, the region 1141 may include a portion 1142 corresponding to the object 1111. For example, in response to the completion of the gesture, the wearable device 101 may identify the image frame corresponding the visual information 1110 as the image frame for searching. For example, the wearable device 101 may correct the image frame corresponding the visual information 1110 based on a vector transformation from an orientation of the wearable device 101 corresponding to the visual information 1110 to an orientation of the wearable device 101 corresponding to the visual information 1130. For example, the region 1141 may be described as an image region of the corrected image frame determined in accordance with the virtual trajectory 1123.

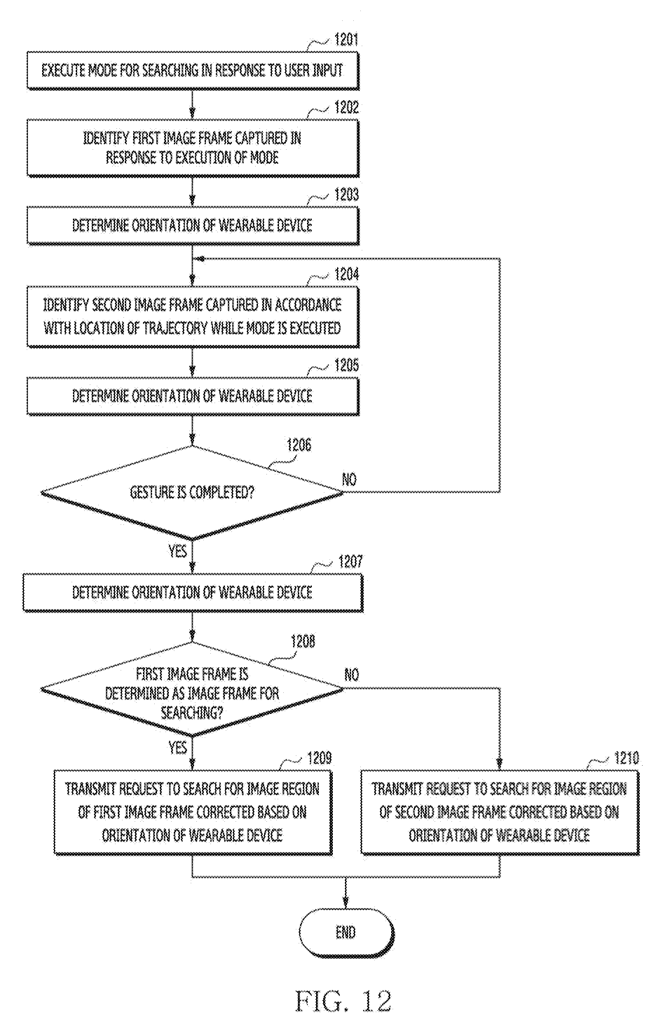

FIG. 12 is a flowchart illustrating a method of determining one of an image frame corresponding to the lowest location of an input object for a gesture and an image frame identified in response to execution of a mode for searching based on a gesture as an image frame for searching based on a gesture, according to an embodiment.

Referring to FIG. 12, in operation 1201, at least one processor 110 may execute a mode for searching based on a gesture in response to a user input. For example, the mode may be described as a mode (e.g., a circle-to-search mode) for executing a search function of application software (e.g., a web browser) for a region of an image determined by a trajectory of the gesture. The at least one processor 110 may receive a user input for executing the mode. For example, the user input may be an input in which a tangible button (e.g., a power button) of a wearable device 101 is pressed. For example, the user input may be an input for executing the application software for the mode. For example, the user input may be an input based on a specified gesture. For example, the mode may be executed in a state in which at least one camera 130 (e.g., a first camera 131) is operated to display pass-through images corresponding to a field of view (FoV) of a user. For example, the pass-through images may correspond to image frames obtained via the at least one camera 130. For example, while the mode is executed, the at least one processor 110 may perform gesture recognition using images obtained via the at least one camera 130 (e.g., a second camera 132) to identify a location of an input object (e.g., the user’s hand or a controller for the wearable device 101) for the gesture. For example, while the mode is executed, the at least one processor 110 may display the trajectory of the gesture indicating a movement path of the input object via at least one display 140.

In operation 1202, in response to the execution of the mode, the at least one processor 110 may store an image frame captured via the least one camera 130 (e.g., the first camera 131 and/or the second camera 132) as a first image frame in buffer memory of the at least one camera 130 or non-volatile memory of the wearable device 101.

In operation 1203, in response to the execution of the mode, the at least one processor 110 may determine an orientation of the wearable device 101 via at least one sensor 160. For example, the orientation of the wearable device 101 may be described as a location and a rotation angle of the wearable device 101 with respect to each of reference axes (e.g., an x-axis, a y-axis, and a z-axis). For example, the at least one processor 110 may store orientation data indicating the orientation of the wearable device 101.

In operation 1204, while the mode is executed, the at least one processor 110 may store the image frame captured via the at least one camera 130 (e.g., the first camera 131 and/or the second camera 132) in accordance with a location of the trajectory as a second image frame, in the buffer memory or the non-volatile memory. For example, while the mode is executed, the at least one processor 110 may store location data indicating the location of the input object. For example, while the mode is executed, the at least one processor 110 may store the image frame captured via the at least one camera 130 as the second image frame based on identifying the location of the input object lower than the lowest location indicated in accordance with the location data.

In operation 1205, while the mode is executed, the at least one processor 110 may determine the orientation of the wearable device 101 via the at least one sensor 160 based on identifying the location of the input object lower than the lowest location indicated in accordance with the location data. For example, the at least one processor 110 may store the orientation data indicating the orientation of the wearable device 101.

In operation 1206, the at least one processor 110 may determine whether a gesture for searching has been completed. For example, the at least one processor 110 may identify completion of the gesture for searching based on identifying a gesture of the input object (e.g., the user’s hand) corresponding to a pinch out gesture. For example, the at least one processor 110 may identify the completion of the gesture for searching based on a user input to the input object (e.g., the controller). For example, the at least one processor 110 may perform the operation 1204 in accordance with determination that the gesture has not been completed (e.g., in a case of NO of the operation 1206).

In operation 1207, in response to the completion of the gesture (e.g., in a case of YES of the operation 1206), the at least one processor 110 may determine the orientation of the wearable device 101 via the at least one sensor 160. For example, the at least one processor 110 may store the orientation data indicating the orientation of the wearable device 101.

In operation 1208, the at least one processor 110 may determine one of the first image frame and the second image frame as the image frame for searching. For example, the at least one processor 110 may determine one of the first image frame and the second image frame as the image frame for searching, based on a comparison between a difference between a first orientation of the wearable device 101 and a second orientation of the wearable device 101, and a difference between the second orientation of the wearable device 101 and a third orientation of the wearable device 101. For example, the first orientation may be an orientation of the wearable device 101 determined by the at least one processor 110, when the second image frame corresponding to the lowest location of the input object is captured (or stored). For example, the second orientation may be an orientation of the wearable device 101 determined by the at least one processor 110, when the at least one processor 110 responds to the completion of the gesture. For example, the third orientation may be an orientation of the wearable device 101 determined by the at least one processor 110, when the first image frame is captured (or stored) in response to the execution of the mode. For example, the at least one processor 110 may determine the second image frame as the image frame for searching, based on the difference between the first orientation and the second orientation smaller than the difference between the second orientation and the third orientation. For example, the at least one processor 110 may determine the first image frame as the image frame for searching based on the difference between the first orientation and the second orientation greater than the difference between the second orientation and the third orientation.

In operation 1209, the at least one processor 110 may transmit, to an external electronic device (e.g., a server 1508), a request to search for an image region of the first image frame corrected based on the second orientation and the third orientation, based on determining the first image frame as the image frame for searching (e.g., in a case of YES of the operation 1208). For example, the at least one processor 110 may correct the first image frame based on a vector transformation from the third orientation to the second orientation. For example, in response to the completion of the gesture, the at least one processor 110 may identify the image region of the first image frame corrected based on the vector transformation, in accordance with the gesture. For example, when the gesture is completed, the image region may be described as a region corresponding to the trajectory of the gesture in the first image frame. For example, the image region may include an object of interest corresponding to the trajectory of the gesture among one or more objects included in the first image frame for searching.

In operation 1210, the at least one processor 110 may transmit, to the external electronic device (e.g., the server 1508), a request to search for an image region of the second image frame corrected based on the first orientation and the second orientation, based on determining the second image frame as the image frame for searching (e.g., in a case of NO of the operation 1208). For example, the at least one processor 110 may correct the second image frame based on a vector transformation from the first orientation to the second orientation. For example, in response to the completion of the gesture, the at least one processor 110 may identify the image region of the second image frame corrected based on the vector transformation, in accordance with the gesture. For example, when the gesture is completed, the image region may be described as a region corresponding to the trajectory of the gesture in the second image frame. For example, the image region may include an object of interest corresponding to the trajectory of the gesture among one or more objects included in the second image frame for searching.

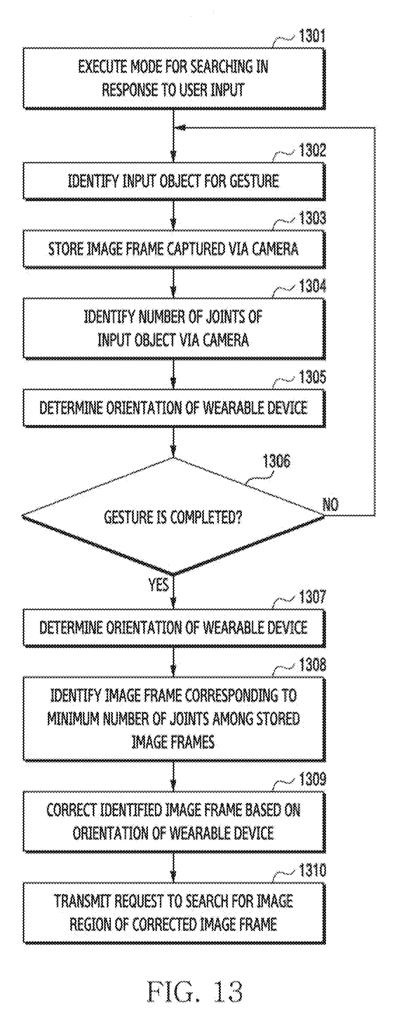

FIG. 13 is a flowchart illustrating a method of identifying an image frame for searching among image frames captured via a camera in accordance with the number of joints of an input object for a gesture, according to an embodiment.

Referring to FIG. 13, in operation 1301, at least one processor 110 may execute a mode for searching based on a gesture in response to a user input. For example, the mode may be described as a mode (e.g., a circle-to-search mode) for executing a search function of application software (e.g., a web browser) for an image region of an image frame determined by a trajectory of the gesture. The at least one processor 110 may receive a user input for executing the mode. For example, the user input may be an input in which a tangible button (e.g., a power button) of a wearable device 101 is pressed. For example, the user input may be an input for executing the application software for the mode. For example, the user input may be an input based on a specified gesture. For example, the mode may be executed in a state in which at least one camera 130 (e.g., a first camera 131) is operated to capture images corresponding to a field of view (FoV) of a user. For example, while the mode is executed, the at least one processor 110 may perform gesture recognition using images obtained via the at least one camera 130 (e.g., a second camera 132) to identify a location of an input object (e.g., the user’s hand or a controller for the wearable device 101) for the gesture. For example, while the mode is executed, the at least one processor 110 may display the trajectory of the gesture indicating a movement path of the input object via at least one display 140. For example, the gesture may be described as a movement of the user’s body to manipulate the wearable device or a movement of an object in accordance with the movement of the user’s body to manipulate the wearable device.

In operation 1302, the at least one processor 110 may identify the input object for the gesture while the mode is executed. For example, the at least one processor 110 may identify initiation of a gesture for searching via the input object, while the mode is executed. For example, the wearable device 101 may identify the initiation of the gesture for searching based on identifying a gesture of the input object (e.g., the user’s hand) corresponding to a pinch in gesture using the images obtained via the at least one camera 130 (e.g., the second camera 132). For example, the at least one processor 110 may perform operation 1303, operation 1304, and/or operation 1305 sequentially or in parallel based on the identification of the input object.

In the operation 1303, based on the identification of the input object, the at least one processor 110 may store an image frame captured via the at least one camera 130 (e.g., the first camera 131 and/or the second camera 132) in buffer memory of the at least one camera 130 or non-volatile memory of the wearable device 101.

In the operation 1304, based on the identification of the input object, the at least one processor 110 may identify the number of joints of the input object (e.g., the user’s hand) via the at least one camera 130.

In the operation 1305, based on the identification of the input object, the at least one processor 110 may determine an orientation of the wearable device 101 via at least one sensor 160. For example, the orientation of the wearable device 101 may be described as a location and a rotation angle of the wearable device 101 with respect to each of reference axes (e.g., an x-axis, a y-axis, and a z-axis). For example, the at least one processor 110 may store orientation data indicating the orientation of the wearable device 101.

In operation 1306, the at least one processor 110 may determine whether the gesture for searching has been completed, using the images obtained via the at least one camera 130 (e.g., the second camera 132). For example, the at least one processor 110 may identify the completion of the gesture for searching based on identifying a gesture of the input object (e.g., the user’s hand) corresponding to a pinch out gesture. For example, the at least one processor 110 may perform the operation 1302 in accordance with determination that the gesture has not been completed (e.g., in a case of NO of the operation 1306). For example, the at least one processor 110 may perform operation 1307 and operation 1308 sequentially or in parallel in accordance with determination that the gesture has been completed (e.g., in a case of YES of the operation 1306).

In the operation 1307, in response to the completion of the gesture (e.g., in a case of YES of the operation 1306), the at least one processor 110 may determine the orientation of the wearable device 101 via the at least one sensor 160. For example, the at least one processor 110 may store the orientation data indicating the orientation of the wearable device 101.

In the operation 1308, the at least one processor 110 may identify an image frame corresponding to the minimum number of joints included in the input object among image frames stored in the buffer memory or the non-volatile memory as an image frame for searching.

In operation 1309, the at least one processor 110 may correct the identified image frame based on the orientation of the wearable device 101. For example, the at least one processor 110 may correct the identified image frame based on a first orientation and a second orientation of the wearable device 101. For example, the first orientation may be an orientation of the wearable device 101 determined by the at least one processor 110, when the image frame corresponding to the minimum number of joints included in the input object is captured (or stored). For example, the second orientation may be an orientation of the wearable device 101 determined by the at least one processor 110, when the at least one processor 110 responds to the completion of the gesture. For example, the at least one processor 110 may correct the identified image frame based on a vector transformation from the first orientation to the second orientation.

In operation 1310, in response to the completion of the gesture, the at least one processor 110 may transmit a request to search for an image region of the corrected image frame to an external electronic device (e.g., a server 1508). For example, in response to the completion of the gesture, the at least one processor 110 may identify the image region of the corrected image frame in accordance with the gesture. For example, when the gesture is completed, the image region may be described as a region corresponding to the trajectory of the gesture in the image frame. For example, the image region may include an object of interest corresponding to the trajectory of the gesture among one or more objects included in the image frame for searching. For example, the at least one processor 110 may execute the search function of the application software (e.g., the web browser) for the image region to transmit the request to search for the image region of the corrected image frame in response to the completion of the gesture. For example, in response to the completion of the gesture, the at least one processor 110 may display a representation of the image region of the corrected image frame and a result of searching for the image region via the at least one display 140. For example, the at least one processor 110 may increase accuracy of searching based on the gesture by identifying the image frame corresponding to the minimum number of joints included in the input object for the gesture as the image frame for searching while the mode is executed.

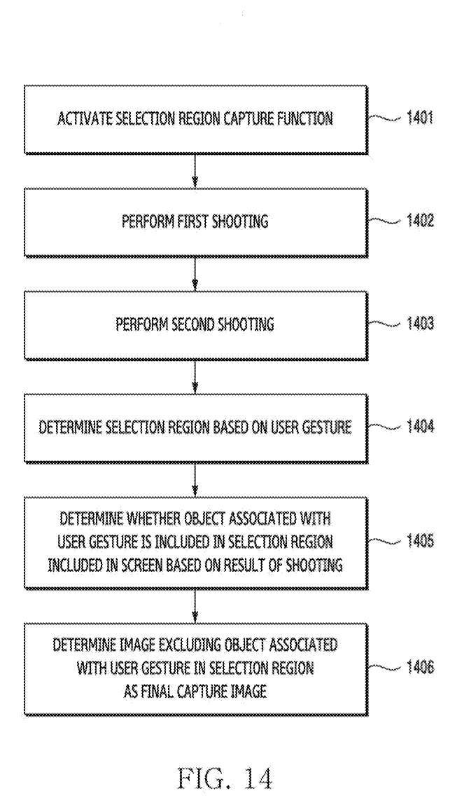

FIG. 14 is a flowchart illustrating a method of determining an image excluding an input object for a gesture among images captured via a camera as an image for searching, according to an embodiment.

Referring to FIG. 14, in operation 1401, at least one processor 110 may activate a selection region capture function. For example, the selection region capture function may correspond to a mode for searching based on a gesture.

In operation 1402, the at least one processor 110 may perform a first shooting within a selection region capture period, which is until a time point when a final capture image is determined based on an image included in a selection region. For example, the first shooting may be performed right after a time point when the selection region capture function is activated, but is not limited thereto.

That is, in this embodiment, a first image and/or a second image may not be stored based on an identified location (e.g., the lowest location) of an input object for a gesture as in the above-described other embodiment, but the final capture image may be determined by selecting an image in which a portion or all of the input object is excluded based on an image captured or derived at any one time point or at least two time points regardless of the location of the input object, or by combining images captured or derived at least two or more time points and generating an image in which a portion or all of the input object is excluded. Moreover, a user gesture is not necessarily limited to a dynamic gesture, and may also include a static gesture.

In operation 1403, the at least one processor 110 may perform a second shooting within the selection region capture period after the first shooting is performed. For example, the user gesture may be a dynamic movement of the object (e.g., the input object for the gesture). For example, the second shooting may be performed at a time point when the lowest point of a trajectory formed by the dynamic movement of the object is identified, but is not limited thereto.

In operation 1404, the at least one processor 110 may determine the selection region based at least in part on a user gesture performed within a range included at least once in a field of view (FoV) of at least one camera 130 in a gesturing process from a time point when the selection region capture function is activated.

In operation 1405, the at least one processor 110 may determine whether an object associated with the user gesture is included in a first selection region, which is a region substantially equal to the selection region, included in a first image obtained based on a result of the first shooting. For example, the at least one processor 110 may determine whether an object associated with the user gesture is included in a second selection region, which is a region substantially equal to the selection region, included in a second image obtained based on a result of the second shooting and the first selection region. For example, at least one of the first image and the second image may be selected from screens obtained based on a result of a plurality of shootings performed in the selection region capture period. For example, the first image and/or the second image may be some frames derived from a result of video shooting performed within the selection region capture period.

In operation 1406, the at least one processor 110 may determine an image excluding a portion or all of an object associated with the user gesture in the selection region as the final capture image.

For example, the at least one processor 110 may select any one of the first selection region and the second selection region.

For example, the final capture image excluding a portion or all of the object may be determined by combining at least a portion of an image included in the first selection region and at least a portion of an image included in the second selection region. That is, in a case that the object (e.g., the input object for the gestures) is included in both the first selection region and the second selection region but a location of the object is different on the first selection region and the second selection region, the final capture image may be determined by generating an image in which at least a portion of the object is removed by combining two images.

For example, the user gesture may include a dynamic movement of the object performed in the selection region capture period. For example, the selection region may be determined based at least in part on a trajectory formed by the dynamic movement of the object.

For example, the user gesture may include a static pose of the object. For example, the selection region may be determined based at least in part on the static pose of the object. That is, as a user distinguishes the selection region and a non-selection region by generating various closed-curve shapes or shapes close to a closed curve using one hand or both hands, the selection region may be determined.

A wearable device 101 may correspond to an electronic device 1501 described with reference to FIG. 15 below.

FIG. 15 is a block diagram illustrating an electronic device 1501 in a network environment 1500 according to various embodiments.

Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module(SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, an HDMI connector, a USB connector, an SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to an embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20Gbps or more) for implementing eMBB, loss coverage (e.g., 1564dB or less) for implementing mMTC, or U-plane latency (e.g., 0.5ms or less for each of downlink (DL) and uplink (UL), or a round trip of 15ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The technical problems to be achieved in this document are not limited to those described above, and other technical problems not mentioned herein will be clearly understood by those having ordinary knowledge in the art to which the present disclosure belongs, from the following description.

As described above, a wearable device (e.g., the wearable device 101) may include a first camera (e.g., the first camera 131), a second camera (e.g., the second camera 132), a display (e.g., the at least one display 140), at least one processor (e.g., the at least one processor 110) comprising processing circuitry, and memory (e.g., the memory 120) comprising one or more storage media storing instructions. The first camera may be configured to capture images corresponding to a field of view of a user wearing the wearable device. The second camera may be configured to capture images for gesture recognition. The instructions, when executed by the at least one processor individually or collectively, may cause the wearable device to operate the first camera to capture the images corresponding to the field of view, based on at least a portion of the captured images corresponding to the field of view, display, via the display, pass-through images corresponding to the field of view, execute a mode for searching based on a user input, based on the mode being executed, perform, using images obtained via the second camera, gesture recognition to identify a gesture, and display, via the display, a trajectory of the gesture, wherein the trajectory comprises a first portion of the gesture and a second portion of the gesture, and wherein a location of an input object in the first portion of the trajectory is below a location of the input object in the second portion of the trajectory, identify an image frame of a pass-through image among the pass-through images in which the location of the input object corresponds to the first portion of the trajectory from among image frames captured while the mode for searching is executed, based on a completion of the gesture, identify an image region of the identified image frame in accordance with the gesture, and transmit a request to execute searching for the image region of the identified image frame.

For example, the instructions, when executed by the at least one processor individually or collectively, may cause the wearable device to, based on the mode being executed, store location data indicating a location of the input object, based on the location of the input object being below the lowest location of the input object indicated in accordance with the location data, store one or more image frames from among the image frames captured while the mode for searching is executed, wherein the identified image frame of the pass-through image corresponds to the lowest location of the input object from among the one or more stored image frames.

For example, the instructions, when executed by the at least one processor individually or collectively, may cause the wearable device to store an image frame captured when the location of the input object corresponds to a first location, store an image frame captured when the location of the input object corresponds to a second location being below the first location, and refrain from storing an image frame captured when the location of the input object corresponds to a third location being above the first location.

For example, the wearable device may further include at least one sensor (e.g., the at least one sensor 160). The instructions, when executed by the at least one processor individually or collectively, may cause the wearable device to determine, via the at least one sensor, a first orientation of the wearable device when capturing the identified image frame, determine, via the at least one sensor, a second orientation of the wearable device in response to the completion of the gesture, correct the identified image frame based on the first orientation and the second orientation, and wherein an image region of the corrected image frame is identified as the image region in accordance with the gesture.

For example, the instructions, when executed by the at least one processor individually or collectively, may cause the wearable device to, based on the completion of the gesture, display, via the display, a representation of the image region and a result of searching for the image region.

For example, the identified image frame may be a first image frame. The instructions, when executed by the at least one processor individually or collectively, may cause the wearable device to identify a second image frame captured in response to the execution of the mode; based on the completion of the gesture, identify, using data on an orientation of the wearable device, one of the image region of the first image frame and an image region of the second image frame to transmit the request to execute searching for the image region of the first image frame or to transmit a request to execute searching for the image region of the second image frame.

For example, the wearable device may further include at least one sensor. The instructions, when executed by the at least one processor individually or collectively, may cause the wearable device to determine, via the at least one sensor, a first orientation of the wearable device when capturing the first image frame, determine, via the at least one sensor, a second orientation of the wearable device based on the completion of the gesture, determine, via the at least one sensor, a third orientation of the wearable device when capturing the second image frame, based on a difference between the first orientation and the second orientation less than a difference between the second orientation and the third orientation, identify the image region of the first image frame, and based on the difference between the first orientation and the second orientation greater than the difference between the second orientation and the third orientation, identify the image region of the second image frame.

For example, the first image frame is corrected based on the first orientation and the second orientation, and the second image frame is corrected based on the second orientation and the third orientation.

As described above, a non-transitory computer readable storage medium may store one or more programs. The one or more programs may comprise instructions that, when executed by at least one processor (e. g, the at least one processor 110) a wearable device (e.g., the wearable device 101) with a first camera (e.g., the first camera 131) configured to capture images corresponding to a field of view of a user wearing the wearable device, a second camera (e.g., the second camera 132) configured to capture images for gesture recognition, and a display (e.g., the at least one display 140), cause the wearable device to operate the first camera to capture images corresponding to the field of view, based on at least a portion of the captured images corresponding to the field of view, display, via the display, pass-through images corresponding to the field of view, execute a mode for searching based on a user input, based on the mode being executed, perform, using images obtained via the second camera, gesture recognition to identify a gesture, and display, via the display, a trajectory of the gesture, wherein the trajectory comprises a first portion of the gesture and a second portion of the gesture, and wherein a location of an input object in the first portion of the trajectory is below a location of the input object in the second portion of the trajectory, identify an image frame of a pass-through image among the pass-through images in which a location of the input object corresponds to the first portion of the trajectory from among image frames captured while the mode for searching is executed, based on a completion of the gesture, identify an image region of the identified image frame in accordance with the gesture, and transmit a request to execute searching for the image region of the identified image frame.

For example, the one or more programs may comprise instructions to, when executed by the at least one processor, cause the wearable device to, based on the mode being executed, store location data indicating a location of the input object, based on the location of the input object being below the lowest location of the input object indicated in accordance with the location data, store one or more image frames from among the image frames captured while the mode for searching is executed, wherein the identified image frame of the pass-through image corresponds to the lowest location of the input object from among the one or more stored image frames.

For example, the one or more programs may comprise instructions to, when executed by the at least one processor, cause the wearable device to store an image frame captured when the location of the input object corresponds to a first location, store an image frame captured when the location of the input object corresponds to a second location being below the first location, and refrain from storing an image frame captured when the location of the input object corresponds to a third location being above the first location.

For example, the one or more programs may comprise instructions to, when executed by the at least one processor, cause the wearable device to determine, via at least one sensor, a first orientation of the wearable device when capturing the identified image frame, determine, via the at least one sensor, a second orientation of the wearable device in response to the completion of the gesture, correct the identified image frame based on the first orientation and the second orientation, wherein an image region of the corrected image frame is identified as the image region in accordance with the gesture.

For example, the one or more programs may comprise instructions to, when executed by the at least one processor, cause the wearable device to, based on the completion of the gesture, display, via the display, a representation of the image region and a result of searching for the image region.

For example, the identified image frame may be a first image frame. The one or more programs may comprise instructions to, when executed by the at least one processor, cause the wearable device to identify a second image frame captured in response to the execution of the mode; based on the completion of the gesture, identify, using data on an orientation of the wearable device, one of the image region of the first image frame and an image region of the second image frame to transmit the request to execute searching for the image region of the first image frame or to transmit a request to execute searching for the image region of the second image frame.

For example, the one or more programs may comprise instructions to, when executed by the at least one processor, cause the wearable device to determine, via the at least one sensor, a first orientation of the wearable device when capturing the first image frame, determine, via the at least one sensor, a second orientation of the wearable device based on the completion of the gesture, determine, via the at least one sensor, a third orientation of the wearable device when capturing the second image frame, based on a difference between the first orientation and the second orientation less than a difference between the second orientation and the third orientation, identify the image region of the first image frame, and based on the difference between the first orientation and the second orientation greater than the difference between the second orientation and the third orientation, identify the image region of the second image frame.

For example, the first image frame is corrected based on the first orientation and the second orientation, and the second image frame is corrected based on the second orientation and the third orientation.

As described above, a method may be performed by a wearable device (e.g., the wearable device 101) with a first camera (e.g., the first camera 131) configured to capture images corresponding to a field of view of a user wearing the wearable device, a second camera (e.g., the second camera 132) configured to capture images for gesture recognition, and a display (e.g., the at least one display 140). The method may comprise operating the first camera to capture images corresponding to the field of view, based on at least a portion of the captured images corresponding to the field of view, displaying, via the display, pass-through images corresponding to the field of view, executing a mode for searching based on a user input, based on the mode being executed, performing, using images obtained via the second camera, gesture recognition to identify a gesture, based on the mode being executed, displaying, via the display, a trajectory of the gesture, wherein the trajectory comprises a first portion of the gesture and a second portion of the gesture, and wherein a location of an input object in the first portion of the trajectory is below a location of the input object in the second portion of the trajectory, identifying an image frame of a pass-through image among the pass-through images in which a location of the input object corresponds to the first portion of the trajectory from among image frames captured while the mode for searching is executed, based on a completion of the gesture, identifying an image region of the identified image frame in accordance with the gesture, and transmitting a request to execute searching for the image region of the identified image frame.

As described above, a wearable device (e.g., the wearable device 101) may include a first camera (e.g., the first camera 131), a second camera (e.g., the second camera 132), a display (e.g., the at least one display 140), at least one processor (e.g., the at least one processor 110) comprising processing circuitry, and memory (e.g., the memory 120) comprising one or more storage media storing instructions. The first camera may be configured to capture images corresponding to a field of view of a user wearing the wearable device. The second camera may be configured to capture images for gesture recognition. The instructions, when executed by the at least one processor individually or collectively, may cause the wearable device to operate the first camera to capture images corresponding to the field of view, based on at least a portion of the captured images corresponding to the field of view, display, via the display, pass-through images corresponding to the field of view, execute a mode for searching based on a user input, store an image frame captured in response to the execution of the mode, based on the mode being executed, perform, using images obtained via the second camera, gesture recognition to identify a gesture, and display, via the display, a trajectory of the gesture, based on a completion of the gesture, identify an image region of the image frame in accordance with the gesture, and transmit a request to execute searching for the image region of the image frame.

For example, the wearable device may further include at least one sensor (e.g., the at least one sensor 160). The instructions, when executed by the at least one processor individually or collectively, may cause the wearable device to determine, via the at least one sensor, a first orientation of the wearable device when capturing the image frame, determine, via the at least one sensor, a second orientation of the wearable device in response to the completion of the gesture, correct the image frame based on the first orientation and the second orientation, and wherein an image region of the corrected image frame is identified as the image region in accordance with the gesture.

For example, the instructions, when executed by the at least one processor individually or collectively, may cause the wearable device to, based on the completion of the gesture, display, via the display, a representation of the image region and a result of searching for the image region.

For example, the identified image frame may be a first image frame. The instructions, when executed by the at least one processor individually or collectively, may cause the wearable device to identify a second image frame captured in accordance with a location of the trajectory identified based on the mode being executed; and based on the completion of the gesture, identify, using data on an orientation of the wearable device, one of the image region of the first image frame and an image region of the second image frame to transmit the request to execute searching for the image region of the first image frame or to transmit a request to execute searching for the image region of the second image frame.

As described above, a non-transitory computer readable storage medium may store one or more programs. The one or more programs may comprise instructions to, when executed by a wearable device (e.g., the wearable device 101) with a first camera (e.g., the first camera 131) configured to capture images corresponding to a field of view of a user wearing the wearable device, a second camera (e.g., the second camera 132) configured to capture images for gesture recognition, and a display (e.g., the at least one display 140), cause the wearable device to operate the first camera to capture images corresponding to the field of view, based on at least a portion of the captured images corresponding to a field of view, display, via the display, pass-through images corresponding to the field of view, execute a mode for searching based on a user input, store an image frame captured in response to the execution of the mode, based on the mode being executed, perform, using images obtained via the second camera, gesture recognition to identify a gesture, and display, via the display, a trajectory of the gesture, based on a completion of the gesture, identify an image region of the image frame in accordance with the gesture, and transmit a request to execute searching for the image region of the image frame.

As described above, a method may be performed by a wearable device (e.g., the wearable device 101) with a first camera (e.g., the first camera 131) configured to capture images corresponding to a field of view of a user wearing the wearable device, a second camera (e.g., the second camera 132) configured to capture images for gesture recognition, and a display (e.g., the at least one display 140). The method may comprise operating the first camera to capture images corresponding to the field of view, based on at least a portion of the captured images corresponding to a field of view, displaying, via the display, pass-through images corresponding to the field of view, executing a mode for searching based on a user input, storing an image frame captured in response to the execution of the mode, based on the mode being executed, performing, using images obtained via the second camera, gesture recognition to identify a gesture, while the mode is executed, displaying, via the display, a trajectory of the gesture, baaed on a completion of the gesture, identifying an image region of the image frame in accordance with the gesture, and transmitting a request to execute searching for the image region of the image frame.

As described above, a wearable device (e.g., the wearable device 101) may include a camera (e.g., the at least one camera 130), at least one processor (e.g., the at least one processor 110) comprising processing circuitry, and memory (e.g., the memory 120) comprising one or more storage media storing instructions. The instructions, when executed by the at least one processor individually or collectively, may cause the wearable device to determine a selection region based at least in part on a user gesture performed within a range included at least once in a FoV of the camera in a gesturing process from a time point when a selection region capture function is activated, wherein a first shooting is performed within a selection region capture period, which is until a time point when a final capture image is determined, based on an image included in the selection region, determine whether an object associated with the user gesture is included in a first selection region, which is a region substantially equal to the selection region, included in a first image obtained based on a result of the first shooting, and determine an image excluding a portion or all of an object associated with the user gesture in the selection region as the final capture image.

For example, the first shooting may be performed right after a time point when the selection region capture function is activated.

For example, a second shooting may be further performed in the selection region capture period after the first shooting is performed. The instructions, when executed by the at least one processor individually or collectively, may cause the wearable device to determine whether an object associated with the user gesture is included in a second selection region, which is a region substantially equal to the selection region, included in a second image obtained based on a result of the second shooting and the first selection region, and determine the final capture image excluding a portion or all of the object by selecting any one of the first selection region and the second selection region, or by combining at least a portion of an image included in the first selection region and at least a portion of an image included in the second selection region.

For example, the user gesture may be a dynamic movement of the object performed in the selection region capture period. The selection region may be determined based at least in part on a trajectory formed by a dynamic movement of the object.

For example, the user gesture may be a static pose of the object. The selection region may be determined based at least in part on a static pose of the object.

For example, at least one of the first image and the second image may be selected from screens obtained based on a result of a plurality of shootings performed in the selection region capture period.

For example, the user gesture may be a dynamic movement of the object. The second shooting may be performed at a time point when the lowest point of a trajectory formed by a dynamic movement of the object is identified.

As described above, a method performed by a wearable device (e.g., the wearable device 101) may comprise determining a selection region based at least in part on a user gesture performed within a range included at least once in a FoV of a camera (e.g., the at least one camera 130) in a gesturing process from a time point when a selection region capture function is activated and performing a first shooting within a selection region capture period until a time point when a final capture image is determined, based on an image of the selection region, determining whether an object associated with the user gesture is included in the selection region included in a first image obtained based on a result of the first shooting, and determining an image excluding a portion or all of an object associated with the user gesture in the selection region as the final capture image.

The effects that may be obtained from the present disclosure are not limited to those described above, and any other effects not mentioned herein will be clearly understood by those having ordinary knowledge in the art to which the present disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
a first camera configured to capture images corresponding to a field of view of a user wearing the wearable device;
a second camera configured to capture images for gesture recognition;
a display;
at least one processor comprising processing circuitry; and
memory comprising one or more storage media storing instructions,
wherein the instructions, when executed by the at least one processor individually or collectively, cause the wearable device to:
operate the first camera to capture the images corresponding to the field of view;
based on at least a portion of the captured images corresponding to the field of view, display, via the display, pass-through images corresponding to the field of view;
execute a mode for searching based on a user input;
based on the mode being executed:
perform, using images obtained via the second camera, gesture recognition to identify a gesture,
display, via the display, a trajectory of the gesture, wherein the trajectory comprises a first portion of the gesture and a second portion of the gesture,
wherein a location of an input object in the first portion of the trajectory is below a location of the input object in the second portion of the trajectory;
identify an image frame of a pass-through image among the pass-through images in which the location of the input object corresponds to the first portion of the trajectory from among image frames captured while the mode for searching is executed;
based on a completion of the gesture, identify an image region of the identified image frame in accordance with the gesture; and
transmit a request to execute searching for the image region of the identified image frame.

2. The wearable device of claim 1, wherein the instructions, when executed by the at least one processor individually or collectively, cause the wearable device to:
based on the mode being executed, store location data indicating a location of the input object; and
based on the location of the input object being below the lowest location of the input object indicated in accordance with the location data, store one or more image frames from among the image frames captured while the mode for searching is executed, and
wherein the identified image frame of the pass-through image corresponds to the lowest location of the input object from among the one or more stored image frames.

3. The wearable device of claim 2, wherein the instructions, when executed by the at least one processor individually or collectively, cause the wearable device to:
store an image frame captured when the location of the input object corresponds to a first location;
store an image frame captured when the location of the input object corresponds to a second location being below the first location; and
refrain from storing an image frame captured when the location of the input object corresponds to a third location being above the first location.

4. The wearable device of claim 1, further comprising:
at least one sensor,
wherein the instructions, when executed by the at least one processor individually or collectively, cause the wearable device to:
determine, via the at least one sensor, a first orientation of the wearable device when capturing the identified image frame;
determine, via the at least one sensor, a second orientation of the wearable device based on the completion of the gesture; and
correct the identified image frame based on the first orientation and the second orientation, and
wherein an image region of the corrected image frame is identified as the image region in accordance with the gesture.

5. The wearable device of claim 1, wherein the instructions, when executed by the at least one processor individually or collectively, cause the wearable device to:
based on the completion of the gesture, display, via the display, a representation of the image region and a result of searching for the image region.

6. The wearable device of claim 1, wherein the identified image frame is a first image frame, and
wherein the instructions, when executed by the at least one processor individually or collectively, cause the wearable device to:
identify a second image frame captured in response to the execution of the mode;
based on the completion of the gesture, identify, using data on an orientation of the wearable device, one of the image region of the first image frame and an image region of the second image frame to transmit the request to execute searching for the image region of the first image frame or to transmit a request to execute searching for the image region of the second image frame.

7. The wearable device of claim 6, further comprising:
at least one sensor,
wherein the instructions, when executed by the at least one processor individually or collectively, cause the wearable device to:
determine, via the at least one sensor, a first orientation of the wearable device when capturing the first image frame;
determine, via the at least one sensor, a second orientation of the wearable device based on the completion of the gesture;
determine, via the at least one sensor, a third orientation of the wearable device when capturing the second image frame;
based on a difference between the first orientation and the second orientation less than a difference between the second orientation and the third orientation, identify the image region of the first image frame; and
based on the difference between the first orientation and the second orientation greater than the difference between the second orientation and the third orientation, identify the image region of the second image frame.

8. The wearable device of claim 7, wherein the first image frame is corrected based on the first orientation and the second orientation, and
wherein the second image frame is corrected based on the second orientation and the third orientation.

9. A non-transitory computer readable storage medium storing one or more programs, the one or more programs comprising instructions that, when executed by at least one processor of a wearable device comprising a first camera, a second camera, and a display, cause the wearable device to:
operate the first camera to capture images corresponding to a field of view of a user wearing the wearable device;
display, via the display, pass-through images corresponding to the field of view, based on at least a portion of the captured images corresponding to the field of view;
execute a mode for searching based on a user input;
based on the mode being executed:
perform, using images obtained via the second camera, gesture recognition to identify a gesture;
display, via the display, a trajectory of the gesture, wherein the trajectory includes a first portion of the gesture and a second portion of the gesture, and wherein a location of an input object in the first portion of the trajectory is below a location of the input object in the second portion of the trajectory;
identify an image frame of a pass-through image among pass-through images in which a location of the input object corresponds to the first portion of the trajectory from among image frames captured while the mode for searching is executed;
based on a completion of the gesture, identify an image region of the identified image frame in accordance with the gesture; and
transmit a request to execute searching for the image region of the identified image frame.

10. The non-transitory computer readable storage medium of claim 9, wherein the one or more programs comprise instructions to, when executed by the at least one processor, cause the wearable device to:
based on the mode being executed, store location data indicating a location of the input object; and
based on the location of the input object being below the lowest location of the input object indicated in accordance with the location data, store one or more image frames from among the image frames captured while the mode for searching is executed, and
wherein the identified image frame of the pass-through image corresponds to the lowest location of the input object from among the one or more stored image frames.

11. The non-transitory computer readable storage medium of claim 10, wherein the one or more programs comprise instructions to, when executed by the at least one processor, cause the wearable device to:
store an image frame captured when the location of the input object corresponds to a first location;
store an image frame captured when the location of the input object corresponds to a second location being below the first location; and
refrain from storing an image frame captured when the location of the input object corresponds to a third location being above the first location.

12. The non-transitory computer readable storage medium of claim 9, wherein the one or more programs comprise instructions to, when executed by the at least one processor, cause the wearable device to:
determine a first orientation of the wearable device when capturing the identified image frame;
determine a second orientation of the wearable device in response to the completion of the gesture; and
correct the identified image frame based on the first orientation and the second orientation, and
wherein an image region of the corrected image frame is identified as the image region in accordance with the gesture.

13. The non-transitory computer readable storage medium of claim 9, wherein the one or more programs comprise instructions to, when executed by the at least one processor, cause the wearable device to:
based on the completion of the gesture, display, via the display, a representation of the image region and a result of searching for the image region.

14. The non-transitory computer readable storage medium of claim 9, wherein the identified image frame is a first image frame, and
wherein the one or more programs comprise instructions to, when executed by the at least one processor, cause the wearable device to:
identify a second image frame captured in response to the execution of the mode; and
based on the completion of the gesture, identify, using data on an orientation of the wearable device, one of the image region of the first image frame and an image region of the second image frame to transmit the request to execute searching for the image region of the first image frame or to transmit a request to execute searching for the image region of the second image frame.

15. The non-transitory computer readable storage medium of claim 14, wherein the one or more programs comprise instructions to, when executed by the at least one processor, cause the wearable device to:
determine a first orientation of the wearable device when capturing the first image frame;
determine a second orientation of the wearable device in response to the completion of the gesture;
determine a third orientation of the wearable device when capturing the second image frame;
based on a difference between the first orientation and the second orientation less than a difference between the second orientation and the third orientation, identify the image region of the first image frame; and
based on the difference between the first orientation and the second orientation greater than the difference between the second orientation and the third orientation, identify the image region of the second image frame.

16. The non-transitory computer readable storage medium of claim 15, wherein the first image frame is corrected based on the first orientation and the second orientation, and
wherein the second image frame is corrected based on the second orientation and the third orientation.

17. A wearable device comprising:
a first camera configured to capture images corresponding to a field of view of a user wearing the wearable device;
a second camera configured to capture images for gesture recognition;
a display;
at least one processor comprising processing circuitry; and
memory comprising one or more storage media storing instructions,
wherein the instructions, when executed by the at least one processor individually or collectively, cause the wearable device to:
operate the first camera to capture images corresponding to the field of view;
based on at least a portion of the captured images corresponding to the field of view, display, via the display, pass-through images corresponding to the field of view;
execute a mode for searching based on a user input;
store an image frame captured in response to the execution of the mode;
based on the mode being executed:
perform, using images obtained via the second camera, gesture recognition to identify a gesture, and
display, via the display, a trajectory of the gesture;
based on a completion of the gesture, identify an image region of the image frame in accordance with the gesture; and
transmit a request to execute searching for the image region of the image frame.

18. The wearable device of claim 17, further comprising:
at least one sensor,
wherein the instructions, when executed by the at least one processor individually or collectively, cause the wearable device to:
determine, via the at least one sensor, a first orientation of the wearable device when capturing the image frame;
determine, via the at least one sensor, a second orientation of the wearable device in response to the completion of the gesture; and
correct the image frame based on the first orientation and the second orientation,
wherein an image region of the corrected image frame is identified as the image region in accordance with the gesture.

19. The wearable device of claim 17, wherein the instructions, when executed by the at least one processor individually or collectively, cause the wearable device to:
based on the completion of the gesture, display, via the display, a representation of the image region and a result of searching for the image region.

20. The wearable device of claim 17, wherein the identified image frame is a first image frame, and
wherein the instructions, when executed by the at least one processor individually or collectively, cause the wearable device to:
identify a second image frame captured in accordance with a location of the trajectory identified based on the mode being executed; and
based on the completion of the gesture, identify, using data on an orientation of the wearable device, one of the image region of the first image frame and an image region of the second image frame to transmit the request to execute searching for the image region of the first image frame or to transmit a request to execute searching for the image region of the second image frame.
